(19) United States
(12) Patent Application Publication
(10) Pub. No.: US 2010/0231836 A1
(43) Pub. Date: Sep. 16, 2010

(54) PHASE DIFFERENCE CONTROL MEMBER, LIQUID CRYSTAL DISPLAY AND LIQUID CRYSTAL MATERIAL COMPOSITION FOR FORMING PHASE DIFFERENCE LAYER

(75) Inventor: Norihisa Moriya, Tokyo (JP)

Correspondence Address: OLIFF & BERRIDGE, PLC, P.O. BOX 320850, ALEXANDRIA, VA, 22320-4850, US

(73) Assignee: DAI NIPPON PRINTING CO., LTD., TOKYO (JP)

(21) Appl. No.: 12/733,880

(22) PCT Filed: Sep. 29, 2008
(86) PCT No.: PCT/JP2008/067686

§ 371 Date: Mar. 25, 2010

(30) Foreign Application Priority Data
Sep. 28, 2007 (JP) 2007-254140

(51) Int. Cl. G02F 1/1335; G02B 27/28

(52) U.S. Cl. 349/118; 359/485; 359/502

(57) ABSTRACT

Provided is a phase difference control member which has a function to suppress a surface step amount and an excellent optical compensation function for the optical phase difference caused by a deflection plate. In the phase difference control member, the phase difference layer has an optical axis standing against the surface having a normal in the thickness direction of the phase difference layer and a surface step amount T of the phase difference layer is smaller than 500 nm. When the phase difference layer has refraction factors nx, ny nz in the direction of the X axis, Y axis, and Z axis, the nx, ny nz for the light of wavelength 589 nm and a coefficient P are in the relationship of P=(nz−((nx+ny/)2)) and the coefficient P and a thickness d (nm) of the phase difference layer satisfy the following expressions: 0.005≦P≦0.04 (Expression 1) d≦2000 (Expression 2) 10≦P×d≦40 (Expression).

### TECHNICAL FIELD

The present invention relates to a phase difference controlling member, a liquid crystal display and a liquid crystal material composition for forming a phase difference layer.

### BACKGROUND ART

In an in-plane switching liquid crystal display (IPS-LCD) having an IPS (in-plane switching) mode as a display mode, since liquid crystal molecules are horizontally oriented or aligned in plane at the time of black display (dark display), there is advantage in that a viewing angle is naturally wide and display characteristics are excellent.

As the IPS-LCD, in the application as a general home television set, color displayable type LCDs are employed in many cases, on the other hand, in a case of application as a monitor for displaying a medical-purpose image (such as a monitor for an X-ray apparatus) among industrial monitors, white and black displaying type LCDs capable of allowing a one pixel area to be as small as possible are employed in most cases since the resolution needs to be increased, rather than the color displayable type LDCs.

A conventional example of a color-displayable type IPS-LCD is shown in FIG. 6.

In the IPS-LCD 151 shown in FIG. 6, a substrate structure 225 is configured to include a substrate portion (TFT array substrate) 223 where switch devices (not shown) such as TFTs (thin film transistors) and electrodes (not shown) made of an ITO (indium tin oxide) layer or the like are formed on a transparent glass substrate 141 and an opposite substrate portion (color filter) 222 disposed to face the substrate portion 223, and a driving liquid crystal layer 128 capable of changing the orientation of the liquid crystal molecules 144 according to a change in an electric field is formed by inserting and sealing a driving liquid crystal composition 124 between a pairs of the substrate portions 222 and 223. In order to prevent occurrence of a change in a gap between the pair of substrate portions 222 and 223, a plurality of pillars 103 having a function of sustaining the gap between the substrate portions 222 and 223 are disposed.

At the outer positions of the substrate portions 222 and 223, polarizing plates 133 and 142 are disposed so that light-transmitting axes thereof are perpendicular, i.e. orthogonally cross to each other, and a phase difference film 130 of performing optical compensation by controlling a phase difference of light is disposed between the transparent glass substrate 141 and the polarizing plate 142 in the substrate portion 223.

The opposite substrate portion 222, which constitutes the color filter, includes a coloring layer 113, and a transparent protective layer 134 which is laminated on the surface of the coloring layer 113. The coloring layer 113 has a black matrix 115 which is formed in a predetermined pattern on the surface of a transparent glass substrate 102 through a patterning process, and R (red), B (blue), and G (green) color patterns 116, 117 and 118. The black matrix 115 is formed by using a photoresist or printing ink containing a black pigment and a resin or by using a metal such as chrome. Each of the color patterns 116, 117 and 118 is formed by using a photoresist or printing ink containing a pigment corresponding to each color and a resin. The transparent protective layer 134 may be formed by coating the coloring layer with a polymerizable resin material and curing the resulting product. As a material constituting the transparent protective layer 134, a material of generating a polymerization reaction and a cross-linking reaction is used, and for example, a (metha) acrylate group containing compound, an epoxy group containing compound, a urethane containing compound or the like having an unsaturated double bond containing group is used.

In the IPS-LCD 151, when the liquid crystal molecules 144 included in the driving liquid crystal layer 128 are driven, a state of the light passing through the driving liquid crystal layer 128 is controlled by switching-controlling the orientation state of the liquid crystal molecule 144 with respect to the in-plane direction of the driving liquid crystal layer 128 by generating an electric field in the in-plane direction of the driving liquid crystal layer 128 (the direction parallel to the plane having the direction of normal line in the thickness direction of the driving liquid crystal layer 128) by the electrodes disposed to the substrate portion 223, so that an image can be formed on a liquid crystal display screen by combining the controlled light.

In this manner, the orientation state of the liquid crystal molecules 144 included in the driving liquid crystal layer 128 is used as a factor for determining an image that is to be formed on the liquid crystal display screen. When the liquid crystal molecules 144 are oriented in an unexpected direction, a non-preferable tilt angle occurs, so that bad influence may be exerted to a quality of an image displayed on the liquid crystal display screen. Therefore, it is preferable that a surface contacting the driving liquid crystal layer 128 in the substrate portions 222 and 223 is configured to be a smooth surface without unevenness. If the contacting surface constituting an uneven surface (step difference surface) having a large step difference amount, the orientation of the liquid crystal molecules 144 at a contact boundary between the substrate portions 222 and 223 and the driving liquid crystal layer 128 is disturbed, so that bad influence may be exerted to the orientation of the liquid crystal molecules 144. By taking into consideration a deterioration in the orientation of the liquid crystal molecules 144 due to the step difference surface, as shown in FIG. 6, a transparent protective layer 134 is laminated on the coloring layer 133 of the opposite substrate 222. Although the coloring layer 113 is formed on the opposite substrate portion 222, since the coloring layer 113 is formed in a predetermined pattern by using the color patterns 116, 117 and 118, and the black matrix 115, there is a problem in that a large number of uneven portions occur on the surface of the coloring layer 113, so that the step difference surface may be easily formed.

If a large step difference is formed in the portion where the black matrix 115 is formed, the orientation of the liquid crystal molecules 144 included in the driving liquid crystal layer 128 is disturbed. If the orientation is disturbed, the orientation of the surrounding liquid crystal molecules 144 is also disturbed, the light used to form an image that is to be formed on the liquid crystal display may not be sufficiently controlled.

Therefore, even in the case where the step difference occurs in the surface contacting with the driving liquid crystal layer 128 at the time of forming the coloring layer 113, there is performed an approach of laminating transparent protective layer 134 on the coloring layer 113 and of reducing the step difference due to the transparent protective layer 134 on the coloring layer 113.

However, in general, in the IPS-LCD 151, in comparison with the other mode LCDs, there is a problem in that the light leakage occurs as viewed from the inclined direction, so that the viewing angle may be narrowed. The first reason of the light leakage is as follows. A relative angle between two light transmitting axes of the two cross-Nicole polarizing plates, in the case where the liquid crystal display screen is viewed from the front direction by an observer, is changed in the case where the screen is viewed from a direction inclined from the front direction of the screen by the observer. Therefore, the light leakage is considered to occur. The second reason is as follows. Since a phase difference occurs due to the protective film adhered to the polarizing plate, the light leakage is consider to occur.

Herein, particularly, the second reason is descried in detail. In the liquid crystal display, the polarizing plates 133 and 142 are disposed. First, as shown in FIG. 8, the polarizing plate 133 is generally configured so that a polarizing film 170 is interposed between protective films 171 and 171. As the polarizing film 170, a film which is formed “by impregnating a PVA (polyvinyl alcohol) film with iodine and by extending the iodine impregnated PVA film in one axial direction to one-axially align the iodine” is used. As the protective film 171, a TAC (triacetyl cellulose) film is generally used. The same configuration is also applied to the polarizing plate 142. In addition, the TAC film used as the protective film 171 generally has a birefringent anisotropy. More specifically, the refractive index in the in-plane direction is larger than the refractive index in the direction of the normal line of the TAC film (the direction of the normal line with respect to the surface of the film), a so-called negative C plate (−C plate) is configured. Therefore, a phase difference of light occurs between the light proceeding in the thickness direction of the protective film 171 and the light proceeding in the direction slightly inclined from the thickness direction, so that bad influence may be exerted on the viewing angle.

The optical compensation for the phase difference generated by the polarizing plate can be implemented by interposing a phase difference film (phase difference film as a so-called positive C plate (+C plate)), in where the refractive index of the in-plane direction is smaller than the refractive index of the direction of normal line and which is separately prepared, between the transparent substrate and the polarizing plate. More specifically, for example, as shown in FIG. 6, a phase difference film 131 having a birefringent characteristic, where the refractive index of the in-plane direction is smaller than the refractive index of the direction of normal line, is separately produced, and the phase difference film 131 is disposed between the transparent glass substrate 102 and the polarizing plate 133. In FIG. 6, the birefringent characteristic of the phase difference film 131 is indicated by a refractive index ellipse 202. However, in this method, there is a problem in that the thickness of the liquid crystal display and the number of film members that are separately disposed outside a pair of the substrates are increased.

Therefore, conventionally, with respect to the optical compensation for improving the viewing angle, there is a proposed method of providing a means, which performs the optical compensation by controlling the phase difference of the light proceeding in the outside direction of the liquid crystal display screen, to the liquid crystal display. As the means, a means for performing the optical compensation by adhering the phase difference film having an optical anisotropy at the outer surface side positions of the pair of substrate portions constituting the liquid crystal display to allow the phase difference film to have an optical compensation function of refracting the light passing through the phase difference film in a birefringent manner is generally employed in liquid crystal displays which have various display modes.

As a method of performing the optical compensation, instead of the aforementioned method of performing the optical compensation by using the phase difference film, there is proposed a method of forming a phase difference layer having an optical anisotropy on a substrate constituting the liquid crystal display by using a liquid crystal material composition and allowing a so called in-cell type phase difference layer to have an optical compensation function (for example, Patent Document of Japanese patent application laid open (JP-A) No. H05-142531).

In the case where the in-cell type phase difference layer is used in the method of performing the optical compensation, a process of adhering the phase difference film by an adhesive needed in the case where the phase difference film is used is unnecessary, so that the layer of adhesive can be removed. Therefore, in comparison with the case where the phase difference film is used, a thinner liquid crystal display can be implemented. In addition, particularly, in the case where the in-cell type phase difference layer that is formed by using polymerizable liquid crystal molecules is assembled in the liquid crystal display, the influence of external heat on the optical compensation function is reduced in comparison with the case where the phase difference film is used, so that a liquid crystal display having high heat resistance can be implemented.

In addition, in the case where the in-cell type phase difference layer is used, a problem of contraction according to time elapse, which occurs in the case where the phase difference film is used, does not occur.

Therefore, with respect to a liquid crystal display including the IPS-LCD, there is desired a liquid crystal display provided with the in-cell type phase difference layer. In addition, there is desired a liquid crystal display having excellent functions, where the in-cell type phase difference layer having the optical compensation function or additional functions is assembled.

### DISCLOSURE OF THE INVENTION

### Problem to be Solved by the Invention

However, in a liquid crystal display including the IPS-LCD, development has merely been focused on a technique of compensating for a phase difference generated by a driving liquid crystal layer by performing optical compensation by using the in-cell type phase difference layer. The development of a liquid crystal display, where an in-cell type phase difference layer of suppressing a phase difference generated by a polarizing plate and having an excellent optical compensation function is provided, has not been sufficiently made.

The present invention provides a phase difference controlling member which can be assembled in a liquid crystal display to allow an in-cell type phase difference layer to have a transparent protective layer function, so that a step difference amount of a surface thereof can be suppressed.

The present invention also provides a phase difference controlling member that has an effective optical compensation function of optically compensating for a phase difference of light generated by a polarizing plate.

The present invention also provides a liquid crystal display in which the phase difference controlling member having the aforementioned functions is assembled.

The present invention also provides a liquid crystal material composition for forming a phase difference layer that is to be laminated on a step difference surface of a phase difference controlling member.

### Means for Solving the Problem

(1) According to an embodiment of the present invention, it is provided that a phase difference controlling member configured by laminating a phase difference layer on a step difference surface that is formed by laminating a base layer on a surface of a substrate, wherein an optical axis of the phase difference layer is erected against a plane having a normal line in a thickness direction of the phase difference layer, wherein a step difference amount T of a surface of the phase difference layer is less than 500 nm, and wherein in the case where x and y axes which are perpendicular, i.e. orthogonally crossed to each other are located in in-plane directions of the phase difference layer and a z axis is set to a direction of a normal line of the phase difference layer, if the x-axial refractive index of the phase difference layer is set to nx, the y-axial refractive index of the phase difference layer is set to ny, and the z-axial refractive index of the phase difference layer is set tonz, respectively, the refractive indices nx, ny and nz and a coefficient P with respect to light having a wavelength of 589 nm have a relationship of P=(nz−((nx+ny)/2)), and the coefficient P and a thickness d (nm) of the phase difference layer satisfy the following respective formulae of 0.005≦P≦0.04 (Formula 1), d≦2000 (Formula 2) and 10≦P×d≦40 (Formula 3).

(2) In the phase difference controlling member disclosed in the above (1), the base layer is a coloring layer having a black matrix and color patterns.

(3) In the phase difference controlling member disclosed in the above (1), the base layer is a black matrix formation layer.

(4) In the phase difference controlling member disclosed in the above (1), the phase difference layer is formed by coating the step difference surface with a liquid crystal material composition containing liquid crystal molecules having a polymerizable functional group and forming a liquid crystal coated layer, applying an orientation characteristic to the liquid crystal molecules included in the liquid crystal coated layer, and irradiating an activated radiation on the liquid crystal coated layer so that the liquid crystal molecules are polymerized.

(5) In the phase difference controlling member disclosed in the above (2), the phase difference layer is formed by coating the step difference surface with a liquid crystal material composition containing liquid crystal molecules having a polymerizable functional group and forming a liquid crystal coated layer, applying an orientation characteristic to the liquid crystal molecules included in the liquid crystal coated layer, and irradiating an activated radiation on the liquid crystal coated layer so that the liquid crystal molecules are polymerized.

(6) In the phase difference controlling member disclosed in the above (1), the phase difference layer is formed by coating the step difference surface with a liquid crystal material composition containing liquid crystal molecules having a polymerizable functional group and a phase difference adjusting additive material and forming a liquid crystal coated layer, applying an orientation characteristic to the liquid crystal molecules included in the liquid crystal coated layer, and irradiating an activated radiation on the liquid crystal coated layer so that the liquid crystal molecules are polymerized.

(7) In the phase difference controlling member disclosed in the above (2), the phase difference layer is formed by coating the step difference surface with a liquid crystal material composition containing liquid crystal molecules having a polymerizable functional group and a phase difference adjusting additive material and forming a liquid crystal coated layer, applying an orientation characteristic to the liquid crystal molecules included in the liquid crystal coated layer, and irradiating an activated radiation on the liquid crystal coated layer so that the liquid crystal molecules are polymerized.

(8) According to an embodiment of the present invention, it is provided that a liquid crystal display where electrodes are disposed to at least one of a pair of opposite substrates, and where a driving liquid crystal layer is formed between the pair of substrates, wherein the phase difference controlling member disclosed in any one of the above (1) to (7) is assembled in one of the pair of substrates.

(9) According to an embodiment of the present invention, it is provided that a liquid crystal material composition for a phase difference layer that is to be laminated on a step difference surface of a phase difference controlling member, wherein the liquid crystal material composition contains liquid crystal molecules having a polymerizable functional group and a phase difference adjusting additive material, wherein an optical axis of the phase difference layer that is formed by using the liquid crystal material composition is erected against a plane having a normal line in a thickness direction of the phase difference layer, wherein a step difference amount T of a surface of the phase difference layer is less than 500 nm, and wherein in the case where x and y axes which are perpendicular, i.e. orthogonally crossed to each other are located in in-plane directions of the phase difference layer and a z axis is set to a direction of normal line of the phase difference layer, if the x-axial refractive index of the phase difference layer is set to nx, y-axial refractive index of the phase difference layer is set to ny, and z-axial refractive index of the phase difference layer is set to nz, respectively, the refractive indices nx, ny and nz and a coefficient P with respect to light having a wavelength of 589 nm have a relationship of P=(nz-((nx+ny)/2)), and the coefficient P and a thickness d (nm) of the phase difference layer satisfy the following respective formulae of

0.005≦P≦0.04 (Formula 1),

d≦2000 (Formula 2) and

10≦P×d≦40 (Formula 3).

### EFFECTS OF THE INVENTION

In the case where the phase difference controlling member according to the present invention is assembled in a liquid crystal display; the in-cell type phase difference layer can be allowed to effectively have a transparent protective layer function and to effectively have an optical compensation function of optically compensating for a phase difference of light generated due to the polarizing plate. In other words, in the case where the phase difference controlling member according to the present invention is assembled in a liquid crystal display, the step difference amount of the surface of the phase difference controlling member is suppressed, so that it is possible to effectively suppress a problem in that an excessively large step difference occurs in the phase difference controlling member. In addition, in the phase difference controlling member, in the case where the liquid crystal display is viewed from the thickness direction of the liquid crystal display screen and the case where the liquid crystal display is viewed from the direction inclined from the thickness direction, it is possible to effectively suppress the light leakage in the inclined direction from the liquid crystal display screen due to the phase difference generated when the light passes through the polarizing plate, so that a liquid crystal display having a wide viewing angle can be manufactured. In addition, according to the present invention, since the transparent protective layer can be omitted, a thin liquid crystal display can be implemented.

In the phase difference controlling member according to the present invention, in addition to the configuration where the black matrix is formed as a base layer, the coloring layer having the black matrix and the color patterns can be formed as a base layer. Therefore, the step difference surface occurring due to the formation of the black matrix or the color patterns can be covered with the phase difference layer. Accordingly, although a step difference surface having excessively large step differences is formed at the time of forming the black matrix or the color patterns, the step difference amount on the uppermost surface of the phase difference controlling member is suppressed, so that the step difference can be effectively reduced.

In general, in the liquid crystal display, an alignment, i.e. orientation layer of controlling the orientation of the liquid crystal molecules constituting the driving liquid crystal layer is formed between the substrate and the driving liquid crystal layer. Therefore, when the liquid crystal display where the phase difference controlling member is assembled is manufactured, the orientation layer is generally disposed between the phase difference controlling member and the driving liquid crystal layer. However, the orientation layer generally has a thickness of about 500 Å, so that the orientation layer is formed to be sufficiently thinner than the phase difference layer. Accordingly, in the orientation layer, it is difficult to reduce the step difference on the uppermost surface of the phase difference controlling member. According to the phase difference controlling member according to the present invention, since the step difference occurring on the uppermost surface of the phase difference layer is configured so that the value of the step difference amount T is less than 500 nm, even in a general liquid crystal display having an orientation layer, it is possible to suppress a problem in that, due to the step difference of the base layer, unexpected orientation may be applied to the liquid crystal molecule included in the driving liquid crystal layer in the vicinity of the boundary surface between the driving liquid crystal layer and the layer contacting with the driving liquid crystal layer, and it is possible to suppress a problem in that the orientation characteristic of the liquid crystal molecules included in the driving liquid crystal layer may be greatly disturbed.

In the phase difference controlling member according to the present invention, since the phase difference layer is formed by coating the step difference surface as a base surface with a liquid crystal material composition including liquid crystal molecules having a polymerizable functional group (polymerizable liquid crystal molecules) to obtain a liquid crystal coated layer and by polymerizing polymerizable liquid crystal molecules included in the obtained liquid crystal coated layer, a polymer (liquid crystal polymer) structure of the polymerizable liquid crystal molecules is formed, so that heat resistance is high. Therefore, a birefringent characteristic representing the optical characteristic of the phase difference layer cannot easily affected by heat. For example, even in a relatively easily temperature-rising ambience such as an in-car ambience, the phase difference controlling member can be easily used. In the case where the polymerizable liquid crystal molecules are three-dimensional cross-linking polymerizable liquid crystal molecules, since a robust polymer structure can be obtained, the aforementioned effect is particularly improved.

In addition, in the phase difference controlling member according to the present invention, a liquid crystal coated layer that is formed by using a liquid crystal material composition added with a phase difference adjusting additive material may be sued to form the phase difference layer, so that the optical compensation function of the phase difference layer can be easily and suitably adjusted according to the design of the liquid crystal display.

In addition, since the phase difference controlling member according to the present invention is assembled in the substrate constituting the liquid crystal display, the in-cell type phase difference layer as a layer structure of compensating for the phase difference generated by the polarizing plate can be combined into the substrate. Therefore, the liquid crystal display can be designed without a process of adhering to a substrate a separately-manufactured member such as a film member provided with a phase difference layer having an optical compensation function of compensating for the phase difference generated by the polarizing plate. Therefore, according to the present invention, an adhesive needed in the case where the phase difference film is used to compensate for the phase difference generated by the polarizing plate is unnecessary, and a configuration having the optical compensation function of compensating for the phase difference generated by the polarizing plate can be provided to the substrate, accordingly, it is possible to reduce a problem in that light scattering occurs due to the adhesive, and it is possible to implement a thinner liquid crystal display.

### BRIEF DESCRIPTION OF THE DRAWINGS

FIG. 1 is a schematic cross-sectional view illustrating a phase difference controlling member according to an embodiment of the present invention;

FIG. 2 is a schematic cross-sectional view illustrating the phase difference controlling member according to the embodiment in a case where a coloring layer is used as a base layer;

FIG. 3 is a schematic plan view illustrating the phase difference controlling member according to the embodiment in the case where the coloring layer is used as the base layer;

FIG. 4 is a schematic cross-sectional view illustrating a phase difference controlling member according to another embodiment in a case where a black matrix formation layer is used as a base layer;

FIG. 5 is an exploded perspective view illustrating a liquid crystal display according to another embodiment, in which the phase difference controlling member according to the present invention is assembled;

FIG. 6 is an exploded perspective view illustrating a conventional liquid crystal display;

FIG. 7 is an explanatory view for explaining a state of an optical axis with respect to a phase difference layer of the phase difference controlling member according to the present invention; and

FIG. 8 is a schematic cross-sectional view illustrating a structure of a polarizing plate.

### BEST MODE FOR CARRYING OUT THE INVENTION

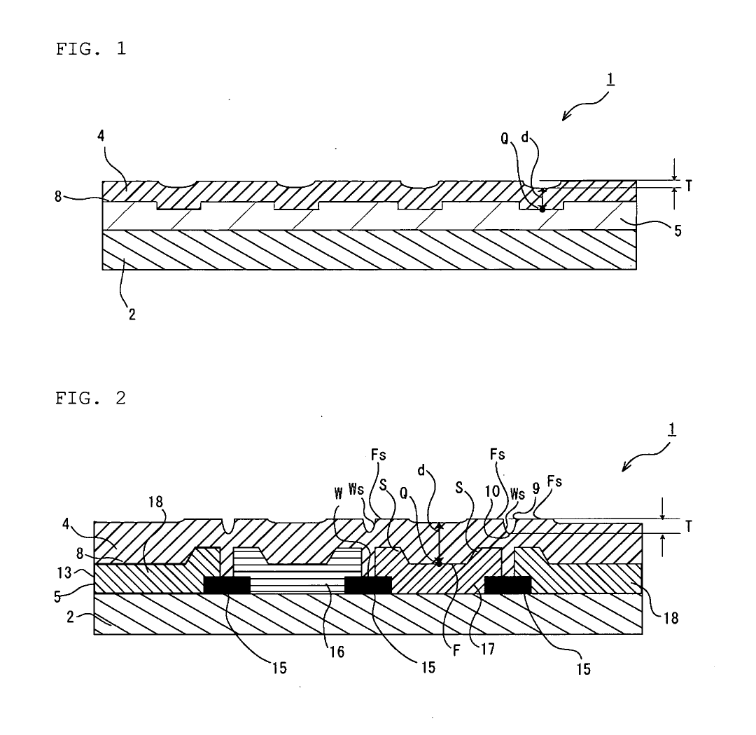

In a phase difference controlling member 1 manufactured according to the present invention, a base layer 5 is laminated on a surface of a substrate 2 to form a step difference surface 8, and a phase difference layer 4 is laminated so as to cover the step difference surface 8 (refer to FIG. 1).

The substrate 2 is made of a material having a light transmitting property. The substrate 2 may be configured as a single layer by using one kind of material. Otherwise, the substrate 2 may be configured as a multiple layer by using plural kinds of materials. A light transmittance of the substrate 2 may be suitably selected.

It is preferable that the material of forming the substrate 2 has an optical isotropy. As the material, a glass substrate made of a glass material or other plate-shaped bodies made of various kinds of materials may be suitably selected. More specifically, a plastic substrate made of poly carbonate, poly methyl methacrylate, polyethylene terephthalate, triacetyl cellulose, or the like may be used. In addition, a film made of polyethersulfone, polysulfone, polypropylene, polyimide, polyamide imide, poly ether ketone, or the like may be used. However, particularly, in the case where the phase difference controlling member is used for a liquid crystal display, it is preferable that the material for forming the substrate is an alkali-free glass.

In the phase difference controlling member 1 according to the present invention, the base layer 5 is laminated on the surface of the substrate 2, a plurality of convex portions that protrude in the upward direction of the surface of the base layer 5 (portions corresponding to relatively wide portions of the upper surface of the phase difference controlling member 1) and a plurality of concave portions that recede in the downward direction of the surface of the base layer 5 (portions corresponding to relatively narrow portions of the upper surface of the phase difference controlling member 1) are formed, so that step differences are formed with the protruding convex portions and the receding concave portions. Therefore, the step difference surface 8 having a plurality of the step differences is formed. The base layer 5 is disposed entirely or partially on the surface of the substrate 2 according to the design of the phase difference controlling member 1. The step difference surface 8 may be formed in combination of the base layer 5 and the substrate 2 or by only the base layer 5.

The base layer 5 may be representatively a coloring layer having a black matrix and a color pattern. Alternatively, the base layer 5 may be a single layer formed by only the black matrix (black matrix formation layer). In addition, the base layer 5 may be a single layer formed by only the color pattern.

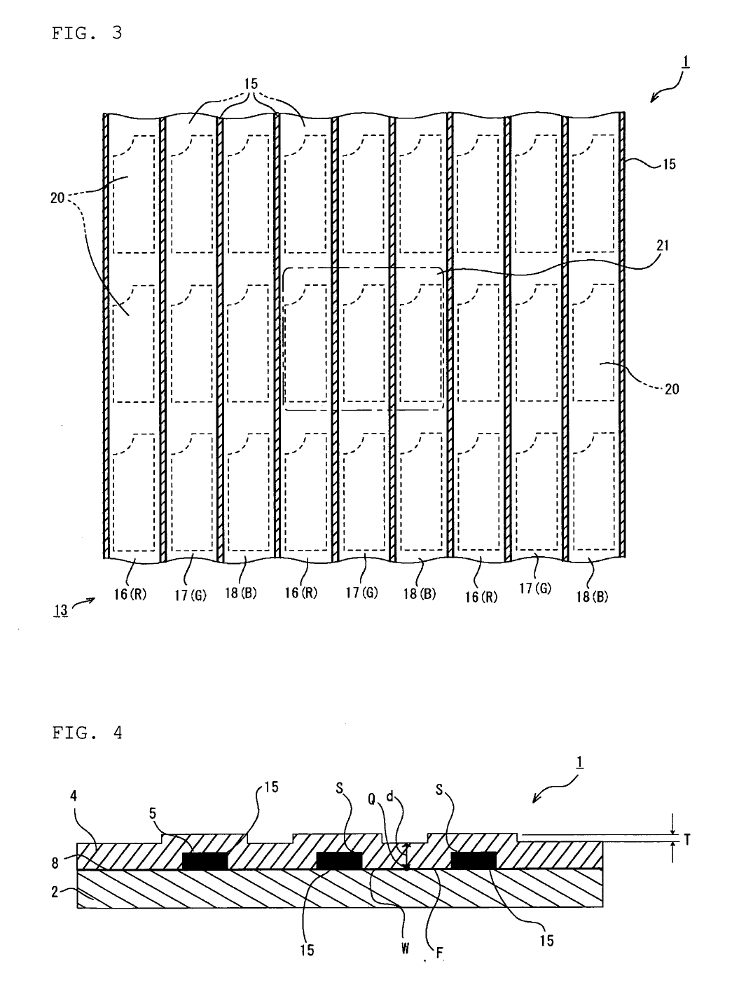

A case of the phase difference controlling member 1 according to the present invention where the base layer 5 is a coloring layer 13 is described. In particular, an example of the phase difference controlling member 1 where a coloring layer having color patterns and a black matrix is formed on the surface of the substrate 2 is described (refer to FIGS. 2 and 3). FIGS. 2 and 3 are a schematic cross-sectional view and a schematic plan view illustrating an embodiment of the phase difference controlling member 1 in the case where the base layer 5 is the coloring layer 13, respectively. In addition, in FIG. 3, the phase difference layer 4 is omitted.

In the phase difference controlling member 1, a light-blocking black matrix 15 is coated on the one surface of the substrate 2 in a vertical-horizontal lattice shape (checkered shape), and a plurality of the portions surrounded by the black matrix are formed as the opening portions 20. At this time, the portion where the black matrix 15 is formed corresponds to a light-blocking portion, and the opening portion 20 corresponds to a light-transmitting portion.

The black matrix 15 may be formed by patterning, for example, a metal thin film having a light blocking property or a light absorbing property such as a metal chrome thin film or a tungsten thin film on the surface of the substrate 2. In addition, the black matrix 15 may be formed by printing an organic material such as a resin containing a black pigment in a predetermined shape.

Three color patterns 16, 17 and 18 are aligned in a strip shape on the substrate 2, on which the black matrix 15 is disposed, so as to cover the opening portions 20, and a coloring layer 13 is formed with the color patterns 16, 17 and the black matrix 15 (refer to FIGS. 2 and 3)). The color patterns 16, 17 and 18 have a light transmitting property and spectrally divide visible light into colors so as to form red (R), green (G) and blue (B) coloring regions, respectively. There, as shown by a two-dotted solid line in FIG. 3, each pixel is formed by each of the three-color, RGB color patterns (red (R) color pattern 16, green (G) color pattern 17 and blue (B) color pattern 18), and the pixels corresponding to the three color patterns 16, 17 and 18 are combined to form one picture element 21.

Each of the color patterns 16, 17 and 18 may be formed by patterning a coated layer corresponding to each color, which is formed by coating on the substrate 2 a coloring material dispersed solution that is obtained by dispersing in a solvent a coloring material, that is, a mixture of a resin and a pigment corresponding to each color, for example, through a photolithography method in a predetermined pattern such as a strip shape. In addition, each of the color patterns may be formed by coating a coloring material dispersed solution on the substrate 2 in a predetermined pattern.

In the case where the black matrix 15 is formed on the coloring layer 13, the black matrix 15 may have the function as a light-blocking portion and other functions, for example, a function of preventing color mixture of the color patterns 16, and 18 that are coated in a strip shape, a function of clarifying an outer line of the picture element 21 by partitioning the opening portions 20 as viewed in plane, and a function of shielding liquid crystal driving circuit or like from the transmitting light.

In the phase difference controlling member 1, the coloring layer 13 is configured to cover the surface of the substrate 2 by using the color patterns 16, 17 and 18 and the black matrix 15, and gap regions are formed between adjacent color patterns 16, 17 and 18, so that the black matrix 15 in the gap regions is exposed to the surface. In this case, in the case where the phase difference controlling member 1 is viewed in plane, the portions of the black matrix 15 in the gap regions are configured as concave portions that recede in the downward direction from the color patterns 16, 17 and 18, and the color patterns 16, 17 and 18 are configured as convex portions that protrude from the black matrix 15 by partially overriding the black matrix 15. Therefore, due to the receding concave portions and protruding convex portions, step differences occur, so that the step difference surface 8 is formed.

In addition, in the phase difference controlling member 1 according to the present invention, the color patterns 16, 17 and 18 constituting the coloring layer 13 may be formed to have different thickness according to different colors. In the case where the color patterns are formed to have different thickness according to different colors, the degrees of protrusion of the surface of the substrate 2 are different among the color patterns 16, 17 and 18, so that the adjacent color patterns having different degrees of protrusion from the surface of the substrate 2 are disposed. According to the configuration, even in the case of the phase difference controlling member 1 where the gap regions are not formed between the adjacent color patterns and the step differences are not formed by the black matrix 15 and the color patterns 16, 17 and 18, step differences are formed between the adjacent color patterns, a similar step difference surface is formed.

In addition, in the phase difference controlling member 1, the coloring layer may not be provided with the black matrix 15 according to usage or optical specifications thereof. In this case, if the color patterns are formed to have different thickness according to colors as described above, a similar step difference surface may be formed.

In the phase difference controlling member 1 according to the present invention, the arrangement of the black matrix 15 is not limited to the rectangular lattice shape, but the black matrix may be formed in a stripe shape or a triangular lattice shape. In addition, the color patterns constituting the coloring layer 13 are also limited to a three-color RGB color system, but the color patterns may be formed in a CMY color system that is the complementary color system thereof. Furthermore, the color patterns may be formed by employing a mono-color system, a two-color system, or four-or-more color system. In addition, the shape of the color patterns is not limited to the strip shape, but it may be a shape where a plurality of fine patterns such as a rectangular shape or a triangular shape is distributed on the substrate 2, or other various shapes of patterns according to purposes.

In the phase difference controlling member 1 according to the present invention, the base layer 5 may be the black matrix 15. In this case, as shown in FIG. 4, similarly to the coloring layer 13, a black matrix 15 having a light blocking property is formed on the one surface of the substrate 2 in a lattice shape in the vertical and horizontal directions through a coating process, so that a plurality of black matrix 15 non-formed regions is formed as the opening portions 20 in a lattice point shape and so that the black matrix 15 formed region is formed as the light-blocking portion.

With respect to the black matrix 15 formed on the surface of the substrate 2 in the black matrix formed region, the surface of the substrate 2 is covered so that the convex portions protruding from the substrate 2 are formed; and in the black matrix (15) non-formed regions, the surface of the substrate 2 is exposed so that the concave portions relatively receding from the black matrix (15) formed region are formed. Therefore, a plurality of step differences is formed with the protruding convex portions and the receding concave portions, so that the step difference surface 8 is formed on the substrate 2.

In addition, the base layer 5 may be configured to have a layered structure including switch devices such as TFTs and transparent electrodes such as ITO layers. The transparent electrode may be formed by suitably performing patterning on the surface of the substrate through a suitably-selected well-known method such as a sputtering method.

With respect to light that propagates through an inner portion of the phase difference layer 4 to be incident to the one of the surfaces thereof and to emit from the other of the surfaces thereof, the phase difference layer 4 is a layer having a function of allowing the light to be subject to birefringence when the light propagates through the inner portion of the phase difference layer 4.

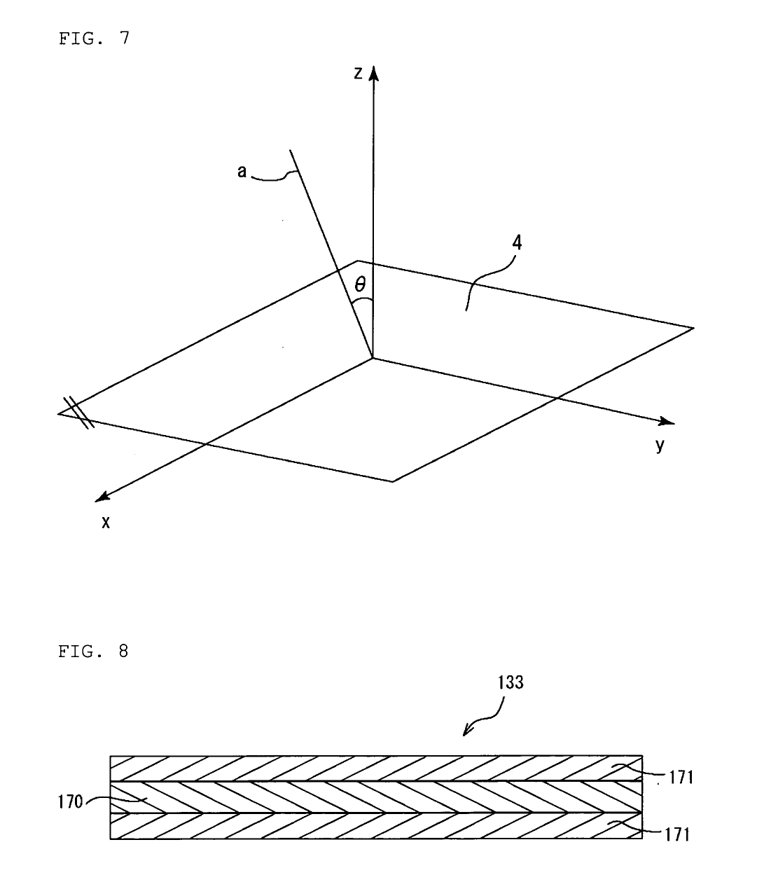

With respect to refractive indices nx, ny and nz, the phase difference layer 4 satisfies nx<nz and ny<nz, and nx and ny has the same or substantially the same relationship, so that the phase difference layer 4 functions as a so-called “+C plate” (positive C plate). However, with respect to the refractive indices of the phase difference layer 4, in an xyz space where the thickness direction of the phase difference layer 4 (direction of normal line of the phase difference layer 4) is set to the z axis (z in FIG. 7) and where the in-plane directions of the phase difference layer 4 (the in-plane directions of the plane normal to the thickness direction of the phase difference layer 4, that is, the directions parallel to the plane) are set to the x axis (x in FIG. 7) and the y axis (y in FIG. 7) that are perpendicular, i.e., orthogonally crossed to each other, the x-axial, y-axial and z-axial light refractive indices are defined as nx, ny and nz, respectively.

The phase difference layer 4 is formed to have a polymer structure that is formed through a polymerization reaction of liquid crystal molecules having a polymerizable functional group in the molecule structure thereof (referred to as polymerizable liquid crystal molecules).

The phase difference layer 4 is formed in the state that liquid crystal molecules are oriented in a specific direction. Since the liquid crystal molecule has an optical axis according to the molecule structure thereof, the liquid crystal molecules have a birefringent characteristic defined according to the state of the optical axis. Therefore, by aligning and fixing the liquid crystal molecules in a specific direction, a layered structure having a birefringent characteristic according to the orientation state can be configured. More specifically, the phase difference layer 4 is configured as a layer having a function of the so-called positive C plate.

The liquid crystal molecules constituting the phase difference layer 4 can be suitably selected from the molecules that allow the phase difference layer 4 to be configured as a layer having a function of the positive C plate. As the liquid crystal molecules, there are used liquid crystal molecules capable of forming a nematic liquid crystal phase or liquid crystal molecules capable of forming a smetic liquid crystal phase.

It is preferable that the liquid crystal molecules constituting the phase difference layer 4 are polymerizable liquid crystal molecules having unsaturated double bond as a polymerizable functional group in the structure of the liquid crystal molecule. In addition, as the polymerizable liquid crystal molecule, there is more preferably used a polymerizable liquid crystal molecule capable of being subject to cross-linking polymerization reaction in a liquid crystal phase state (refer to as a cross-linking polymerizable liquid crystal molecule or a cross-linkable liquid crystal molecule) in terms of heat resistance. It is preferable that the cross-linking polymerizable liquid crystal molecule has unsaturated double bonds (two or more unsaturated double bonds) at the two ends of the molecule structure. In addition, in the case where the phase difference layer 4 is formed by using the cross-linking polymerizable liquid crystal molecules, a cross-linked polymer structure where cross-linking polymerizable liquid crystal molecules are cross-linked to each other is formed in the phase difference layer 4.

As the cross-linkable liquid crystal molecule used to form the phase difference layer 4, there is a nematic liquid crystal molecule having a cross-linking property (cross-linkable nematic liquid crystal molecule) or the like. As an example of the cross-linkable nematic liquid crystal molecule, there is a monomer, an oligomer, a polymer, or the like where at least one polymerizable group such as a (metha)acryloyl group, an epoxy group, an oxytacen group, or an isocyanate group is contained in one molecule. In addition, more preferably, as the cross-linkable liquid crystal molecule, there may be used one compound (compound (I)) selected from compounds expressed by general formula 1 indicated by the following Chemical Formula 1 or a mixture of two or more compounds, one compound (compound (II)) selected from compounds expressed by general formula 2 indicated by the following Chemical Formula 2 or a mixture of two or more compounds, one compound (compound (III)) selected from compounds indicated by the following Chemical Formula 3 or 4 or a mixture of two or more compounds, or a mixture thereof.

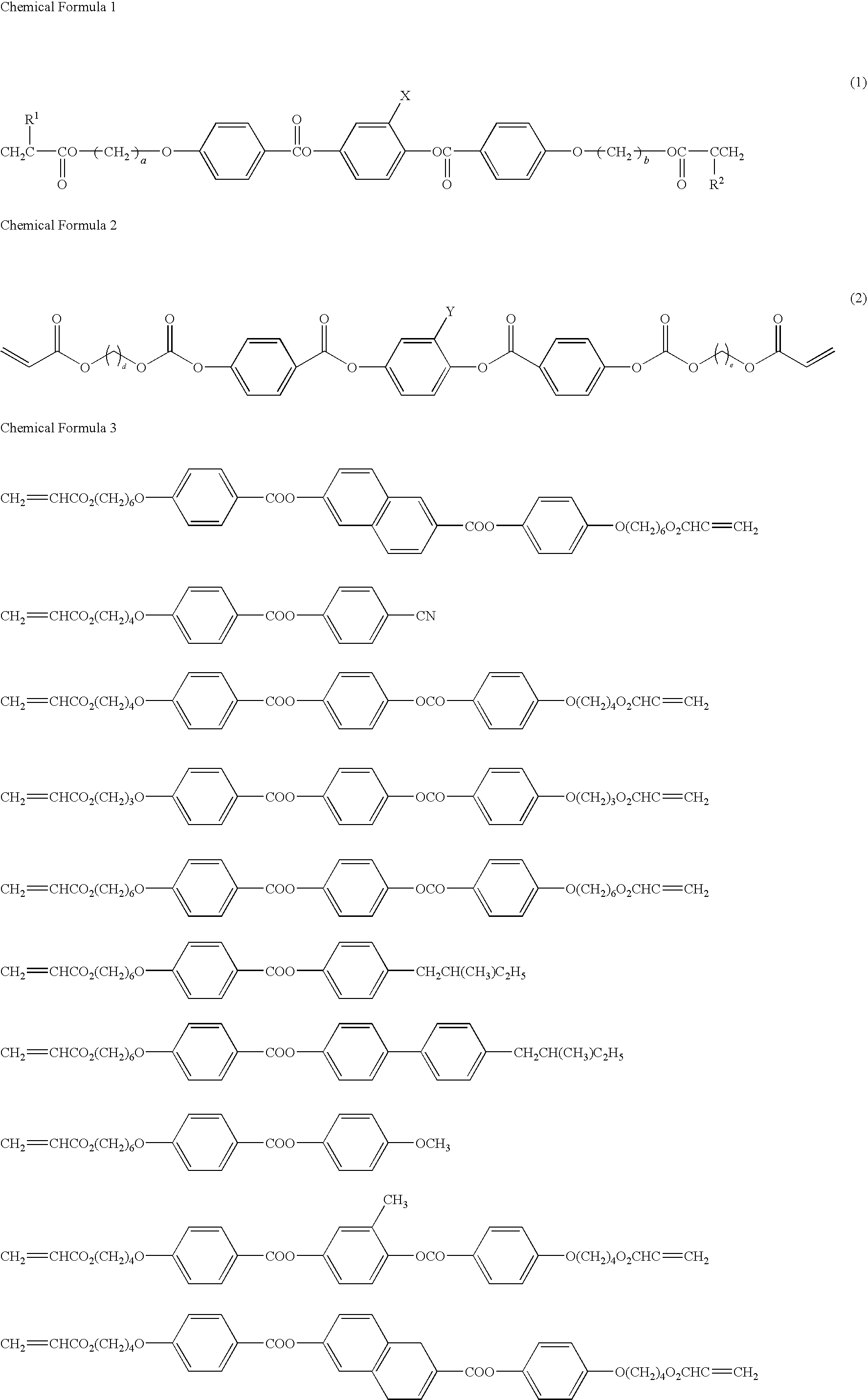

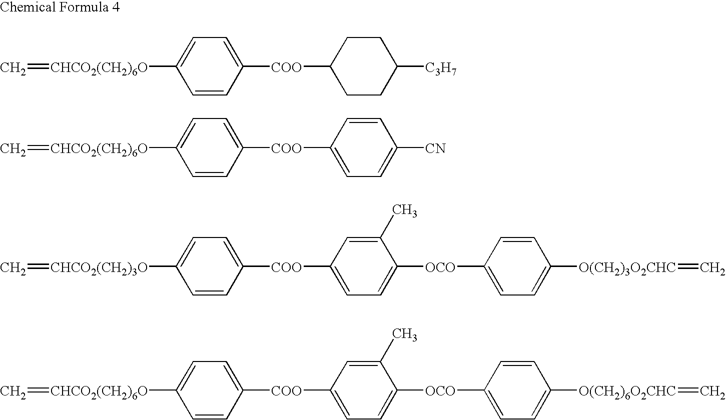

In the general formula 1 indicated by Chemical Formula 1, R¹ and R² denote hydrogen or a methyl group. In order to widen a temperature range where the cross-linkable liquid crystal molecule has a liquid crystal phase, at least one of R¹ and R² is preferably hydrogen, and more preferably, both of R¹ and R² are hydrogen. In addition, X in the general formula 1 and Y in the general formula 2 may be hydrogen, chlorine, bromine, iodine, an alkyl group having carbon numbers 1 to 4, a methoxy group, a cyano group, or a nitro group. More preferably, X and Y are chlorine or a methyl group. In addition, a and b in the general formula 1 that indicate chain lengths between a (metha)acryloyloxy group and an aromatic ring at the two end of the molecular chain and d and e in the general formula 2 may be individually set to an arbitrary integer in a range of 1 to 12, preferably in a range of 4 to 10, more preferably in a range of 6 to 9. A compound (I) expressed by the general formula 1 having a=b=0 or a compound (II) expressed by the general formula 2 having d=e=0 has an insufficient stability, a vulnerability to hydrolysis, and a high self-crystallinity of the compound (I) or (II). In addition, the compound (I) expressed by the general formula 1 or the compound (II) expressed by the general formula 2, where a or b, and d or e are 13 or more, has a low isotropic phase transition temperature (TI). For this reason, in the compounds, the temperature range where the liquid crystal molecules have a stable liquid crystal property (temperature range where the liquid crystal phase is maintained) is narrow, so that the compounds are not preferably used for the phase difference layer 4.

In the aforementioned Chemical Formulas 1, 2, 3 and 4, as the cross-linkable liquid crystal molecule, monomers including liquid crystals having a polymerizability (polymerizable liquid crystal) is exemplified. However, an oligomer of the polymerizable liquid crystals, a polymer of the polymerizable liquid crystals, or the like may be used. In addition, with respect to these oligomers and polymers, well-known oligomers or polymers indicated by the aforementioned Chemical Formulas 1, 2, 3 and 4 may be suitably selected and used.

With respect to the phase difference layer 4, a polymerization degree of liquid crystal molecules (cross-linking polymerization degree in the case of the cross-linking polymerizable liquid crystal molecules) is preferably about 80 or more, and more preferably about 90 or more. If the polymerization degree of the liquid crystal molecules constituting the phase difference layer 4 is less than 80, a uniform aligning property may not be sufficiently maintained. In addition, the polymerization degree (cross-linking polymerization degree) denotes a ratio of polymerizable functional groups of the liquid crystal molecules that are used for the polymerization reaction of the liquid crystal molecules.

The phase difference layer 4 is formed as a layer having an optical compensation function as the following positive C plate by using the aforementioned liquid crystal molecules.

The phase difference layer 4 is formed by aligning and fixing liquid crystal molecules having a positive birefringent anisotropy so that the optical axis thereof is orientated in the z axial direction of the aforementioned xyz space.

More specifically, the phase difference layer 4 may be formed as follows.

First, a liquid crystal material composition is adjusted by mixing liquid crystal molecules such as the aforementioned compound (I), compound (II) or compound (III) constituting the phase difference layer 4 and a solvent. An additive including an orientation enhancing agent for vertically aligning the liquid crystal molecules (refer to as a vertical orientation enhancing agent) may be suitably added to the liquid crystal material composition if needed.

As the solvent used to adjust the liquid crystal material composition, a solvent capable of dissolving the liquid crystal molecules constituting the phase difference layer 4 is used without particular limitation. More specifically, there may be used one or two or more selected from a hydrocarbon series solvent such as benzene, toluene, xylene, n-butyl benzene, diethyl benzene, or tetralin, an ether series solvent such as methoxy benzene, 1,2-dimethoxy benzene, or diethylene glycol dimethyl ether, a ketone series solvent such as acetone, methyl ethyl ketone, methyl isobutyl ketone, cyclohexanone, or 2,4-pentane dione, an ester series solvent such as ethyl acetate, ethylene glycol mono methyl ether acetate, propylene glycol mono methyl ether acetate, propylene glycol mono ethyl ether acetate, or γ-butyrolactone, an amide series solvent such as 2-pyrrolidone, N-methyl-2-pyrrolidone, dimethyl formamide, or dimethyl acetamide, a halogen series solvent such as chloroform, dichloromethane, carbon tetrachloride, dichloroethane, tetrachloro ethane, tri trichloro ethylene, tetrachloro ethylene, chloro benzene, an orthodichlorobenzene, an alcohol series solvent such as t-butyl alcohol, diacetone alcohol, glycerine, monoacetine, ethylene glycol, tri ethylene glycol, hexylene glycol, ethylene glycol mono methyl ether, ethyl cellosolve, or butyl cellosolve, and a phenol series solvent such as phenol or parachlorophenol. In the case where a sufficient solubility of the mixed material constituents of the cross-linkable liquid crystal molecule cannot be obtained by using only one type solvent or in the case where a coating object material (material constituting the substrate) may be eroded at the time of coating the liquid crystal material composition, these problems can be avoided by using a mixture of two or more types of solvents. Among the aforementioned solvents, as a preferable one-type solvent, there are a hydrocarbon series solvent and a glycol mono ether acetate series solvent; and as a preferable mixture of solvent, there is a mixture of a glycol series solvent and an ether series or ketone series solvent. A concentration of mixed material constituents of a liquid crystal material composition is different according to a solubility of a solvent of mixed material constituents used for the liquid crystal material composition or a desired thickness of the phase difference layer. The concentration is generally in a range of 1 to 60 wt %, preferably in a range of 3 to 40 wt %.

As a detailed example of the vertical orientation enhancing agent contained in the liquid crystal material composition, there is a polyimide, a surfactant, or a coupling agent.

In the case where a polyimide is used as the vertical orientation enhancing agent, a polyimide having a long-chain alkyl group is preferable because the thickness of the phase difference layer 4 formed in the phase difference controlling member can be selected from a wide range. In addition, in the case where the vertical orientation enhancing agent is a polyimide, more specifically, SE-7511 or SE-1211 manufactured by NISSAN CHEMICAL INDUSTRIES, Ltd. or JALS-2021-R2 manufactured by JSR Co. may be exemplified as the polyimide.

In the case where a surfactant is used as the vertical orientation enhancing agent, a surfactant capable of homeotropically aligning the polymerizable liquid crystal molecules may be used. However, since the liquid crystal molecules need to be heated up to the liquid crystal phase transition temperature at the time of forming the phase difference layer, the surfactant is required to have heat resistance so that the surfactant is not decomposed at the liquid crystal phase transition temperature. In addition, since the liquid crystal molecules may be dissolved by an organic solvent at the time of forming the phase difference layer 4, the surfactant is required to have a good affinity to the organic solvent that solves the liquid crystal molecules. If a surfactant satisfies these requirements, the surfactant is not limited to a specific type surfactant such as a non-ion series surfactant, a cation series surfactant, or an anion series surfactant. In addition, only one type surfactant may be used, and plural types of surfactants may be combined and used.

In the case where a coupling agent is used as the vertical orientation enhancing agent, as a detailed example of the coupling agent, there is a silane coupling agent that can be obtained through hydrolysis of a silane compound such as n-octyl trimethoxy silane, n-octyl triethoxy silane, decyl trimethoxy silane, decyl triethoxy silane, n-dodecyl trimethoxy silane, n-dodecyl triethoxy silane, octadecyl trimethoxy silane, or octadecyl triethoxy silane, a silane coupling agent containing an amino group, a silane coupling agent containing a fluorine group, or the like. Plural types of the coupling agents may be selected and added to the liquid crystal material composition.

In addition, a photo-polymerization initiator or a sensitizer is added to the liquid crystal material composition if needed.

As an example of the photo-polymerization initiator, there is benzyl (or bibenzoyl), benzoin isobutyl ether, benzoin isopropyl ether, benzophenone, benzoyl benzoate, methyl benzoyl benzoate, 4-benzoyl-4′methyl diphenyl sulfide, benzyl methyl ketal, dimethyl amino methyl benzoate, 2-n-butoxy ethyl 4-dimethyl amino benzoate, isoamyl p-dimethyl amino benzoate, 3,3′-dimethyl-4-methoxy benzophenone, methylo benzoyl formate, 2-methyl-1-(4-(methylthio)phenyl)-2-morpholino propane-1-one, 2-benzyl-2-dimethyl amino-1-(4-morpholino phenyl)-butane-1-one, 1-(4-dodecyl phenyl)-2-hydroxy-2-methylpropane-1-one, 1-hydroxy cyclohexyl phenyl ketone, 2-hydroxy-2-methyl-1-phenyl propane-1-one, 1-(4-isopropyl phenyl)-2-hydroxy-2-methylpropane-1-one, 2-chloro thioxanthone, 2,4-diethyl thioxanthone, 2,4-diisopropyl thioxanthone, 2,4-dimethyl thioxanthone, isopropyl thioxanthone, 1-chloro-4-propoxy thioxanthone, or the like.

In the case where the photo-polymerization initiator is mixed with the liquid crystal material composition, a mixing amount of the photo-polymerization initiator is 0.01 to 10 wt %. In addition, it is preferable that the mixing amount of the photo-polymerization initiator is an amount that does not destruct the orientation of the polymerizable liquid crystal molecules if possible. In terms of this point, the mixing amount is preferably 0.1 to 7 wt %, more preferably 0.5 to 5 wt %.

In addition, in the case where the sensitizer is mixed with the liquid crystal material composition, a mixing amount of the sensitizer can be suitably selected in such a range that the orientation of the polymerizable liquid crystal molecules is not greatly destructed, more specifically, in a range of 0.01 to 1 wt %. With respect to each of the photo-polymerization initiator and the sensitizer, only one type may be used, and two or more types thereof may be combined and used.

After the liquid crystal material composition is adjusted in this manner, the liquid crystal material composition is allowed to coat the step difference surface that is formed by laminating the base layer on the substrate 2, so that a liquid crystal coated layer is produced.

As a method of coating of the liquid crystal material composition, there are suitably used various printing method such as a die coat method, a bar coat method, a slide coat method and a roll coat method, or a method such as a spin coat method.

Next, the polymerizable liquid crystal molecules included in the liquid crystal coated layer that is formed to coat the surface of the step difference surface of the substrate 2 are allowed to have an orientation characteristic as follows. Herein, since the phase difference controlling member 1 is a positive C plate, the liquid crystal molecules constitute a homeotropically oriented phase difference layer. The orientation characteristic of the liquid crystal molecules is obtained by heating the liquid crystal coated layer so that the temperature of the liquid crystal coated layer becomes a temperature or more where the liquid crystal molecules included in the liquid crystal coated layer are in a liquid crystal phase and a temperature or less where the liquid crystal molecules included in the liquid crystal coated layer are in an isotropic phase (liquid phase). A means of heating the liquid crystal coated layer is not limited to a specific one, but a means of maintaining the substrate, where the liquid crystal coated layer is formed, in a heating ambience or a means of heating the liquid crystal coated layer by irradiating the liquid crystal coated layer with infrared light may be used.

In addition to the aforementioned method, the method of aligning the polymerizable liquid crystal molecules may be a method of heating the liquid crystal coated layer up to an isotropic phase temperature according to a state of the polymerizable liquid crystal molecules included in the liquid crystal coated layer or a state of the liquid crystal coated layer and, after that, cooling the liquid crystal coated layer so that the liquid crystal molecules are allowed to be spontaneously oriented during the cooling process or a method of exerting an electric field or a magnetic field in a predetermined direction to the liquid crystal coated layer.

In addition, even in the case where the polymerizable liquid crystal molecules of which the liquid crystal phase temperature is higher than the room temperature and which are, generally, not in a liquid crystal phase at the room temperature are used as the liquid crystal molecules contained in the liquid crystal material composition, if the liquid crystal material composition contains the liquid crystal molecules which are in an over-cooled liquid crystal phase at the room temperature, the liquid crystal material composition may be used as a liquid crystal material composition for forming the liquid crystal coated layer containing the liquid crystal molecules applied with the orientation characteristic at the room temperature within a time interval where the liquid crystal molecules are in the liquid crystal phase.

In this manner, if the liquid crystal molecules contained in the liquid crystal coated layer are applied with the orientation characteristic, the liquid crystal molecules are subject to the polymerization reaction (cross-linked polymerization reaction in the case where the liquid crystal molecules are the cross-linking polymerizable liquid crystal molecules).

The polymerization reaction is performed by irradiating the entire surface of the liquid crystal coated layer contained the liquid crystal molecules that are in a liquid crystal phase state with an activated radiation such as light having a photosensitive wavelength of a photo-polymerization initiator added to the liquid crystal material composition (more specifically, for example, ultraviolet light). At this time, the wavelength of the light irradiated on the liquid crystal coated layer is suitably selected according to the type of the photo-polymerization initiator included in the coated layer. In addition, the light irradiated on the liquid crystal coated layer is not limited to a monochromatic light, but light having a predetermined wavelength range including the photosensitive wavelength of the photo-polymerization initiator may be used.

In addition, the polymerization reaction of the liquid crystal molecules may be performed by a method where the polymerization reaction is partially performed by irradiating (exposing) the liquid crystal coated layer with an activated radiation such as light having a photosensitive wavelength of the photo-polymerization initiator through a photomask having a light blocking pattern in the state that the liquid crystal coated layer is in a liquid crystal phase (referred to as a partial polymerization process) and where, after the partial polymerization process, the polymerization reaction is further performed by heating the liquid crystal coated layer up to a temperature (Ti) where the liquid crystal molecules are in an isotropic phase and, in the state, by further irradiating the liquid crystal coated layer with the activated radiation such as light having the photosensitive wavelength. Alternatively, the polymerization reaction of the liquid crystal molecules may be performed by a method where, after the aforementioned partial polymerization process is performed, the polymerization reaction of the liquid crystal molecules included in the liquid crystal coated layer is performed by thermally polymerizing the liquid crystal molecules by heating the liquid crystal coated layer at the temperature Ti or more until a predetermined polymerization degree is obtained. In addition, the aforementioned temperature Ti is a temperature where the liquid crystal molecules in the liquid crystal coated layer before the polymerization reaction are to be in an isotropic phase.

In addition, in the case where the polymerization reactions of the liquid crystal molecules is performed through the partial polymerization process using the photomask, after the partial polymerization process is performed on the substrate where the liquid crystal coated layer is formed, the substrate is immersed in a solution capable of dissolving a liquid crystal material composition that is in a non-cured state due to an insufficient polymerization reaction of the liquid crystal molecules so as to remove a portion where the polymerization reaction of the liquid crystal molecules in the liquid crystal coated layer from the surface of the substrate, so that a layer structure including liquid crystal molecules having a liquid crystal phase may be formed (patterned) in a predetermined pattern on the substrate.

In addition, the liquid crystal coated layer curing that is performed through the polymerization reaction of the liquid crystal molecules in the liquid crystal coated layer by irradiating the liquid crystal coated layer with the activated radiation may be performed in an air ambience or in an inert gas ambience.

In the phase difference layer 4, with respect to a tilt angle of each of the liquid crystal molecules constituting the polymer structure (cross-linking polymer structure in the case where the liquid crystal molecule is a cross-linking polymerizable liquid crystal molecule), the tilt angles of the liquid crystal molecules that exist at different positions in the thickness direction and in-plane directions of the phase difference layer 4 are preferably substantially zero, and ideally zero. In addition, in the case where the tilt angle of the liquid crystal molecule is zero or substantially zero, it is preferable that the number of liquid crystal molecules of which the tilt angles are equal and of which the azimuthal angles (in the direction of the optical axis of the liquid crystal molecule as viewed from the plane of the phase difference layer 4) are 180° or in the different relation before and after thereof may be equal or substantially equal.

In other words, in the case where individual liquid crystal molecules are expressed by a three-dimensional coordinate system having three perpendicular axes wherein one axis thereof is orientated in the longitudinal direction of the molecule, if the axis of which the refractive index is largest in the refractive indices (N1, N2 and N3) of the liquid crystal molecule in the three axial directions is defined as the longest axis (or the optical axis of the liquid crystal molecule) in the ellipse of the liquid crystal molecule, for example, when the N1 is in maximum among the N1 to the N3, the magnitude of the N1 and the axis having the N1 are defined as the longest axis in the ellipse of the liquid crystal molecule. However, ideally, the optical axis of the liquid crystal molecule is oriented with the thickness direction of the phase difference layer 4. In addition, the three-dimensional coordinate system having three perpendicular axes with respect to the individual liquid crystal molecules is independent of and different from the aforementioned three-dimensional coordinate system having x, y, and z axes with respect to the phase difference layer.

In addition, in the phase difference layer 4, in the case where the tilt angle of the liquid crystal molecule is neither zero nor substantially zero, it is preferable that the number of liquid crystal molecules of which the tilt angles are equal and of which the azimuthal angles (in the direction of the optical axis of the liquid crystal molecule as viewed from the plane of the phase difference layer 4) are 180° or in the different relation before and after thereof may be equal or substantially equal.

In this case, since the optical axis of the phase difference layer 4 is aligned with the thickness direction of the phase difference layer 4, the birefringent characteristic of the phase difference layer 4 is uniform, so that irregularity in the in-plane directions of the phase difference layer 4 is decreased.

In addition, by adjusting the refractive index characteristic as follows, the phase difference amount of the phase difference layer 4 which occurs in the light passing through the phase difference layer 4 can be adjusted. In other words, the optical compensation function can be adjusted.

For example, UV-polymerized thermotropic liquid crystal molecules are used as the liquid crystal molecules included in the liquid crystal material adjusting material, and the optical compensation function of the phase difference layer 4 is suitably adjusted by controlling the temperature at the time of irradiating the liquid crystal coated layer with the ultraviolet light. This is because, in a temperature range where the thermotropic liquid crystal material composition is in the liquid crystal phase, thermal fluctuation of the liquid crystal molecules is increased as the temperature approaches an isotropic temperature (in other words, as the temperature is increased in the temperature range where the liquid crystal material composition shows the liquid crystal phase), so that the refractive index anisotropy of the liquid crystal material composition is decreased. In addition, instead of the method of controlling the temperature at the time of irradiating the liquid crystal coated layer with the ultraviolet light, the UV-polymerized thermotropic liquid crystal molecules are used as the liquid crystal molecules, and the optical compensation function of the phase difference layer 4 may be adjusted by controlling the temperature after the UV irradiation or controlling the baking time.

In addition, in the case where the phase difference layer is formed by adding an additive material having no liquid crystal phase to the liquid crystal material composition within a range where the phase difference layer having a function as a positive C plate can be formed and by forming the liquid crystal coated layer by using the liquid crystal material composition added with the additive material, the optical compensation function of the phase difference layer 4 may be effectively adjusted. In this case, as the additive material added to the liquid crystal material composition (phase difference adjusting additive material), any material capable of maintaining the transparent property of the phase difference layer 4 and the sufficient hardness after the curing can be used irrespective of an organic or inorganic material. More specifically, (metha) acrylate, an epoxy acrylate oligomer, a reactive epoxy resin, or silica beads, barium sulfate, or the like can be used.

In the case where the phase difference adjusting additive material is added to the liquid crystal material composition, it is preferable that the phase difference adjusting additive material has a polymerizable functional group in the molecule thereof, so that the phase difference adjusting additive material is received in a network of the polymer chain (within the polymer chain) of the liquid crystal molecules, which are configured through the polymerization of the polymerizable liquid crystal molecules, without separation. In the case where the phase difference adjusting additive material is used, it is possible to suppress a problem in that the phase difference adjusting additive material is phase-separated from the liquid crystal material composition or a problem in the hardness of the phase difference layer is excessively decreased due to the adding of the phase difference adjusting additive material. In addition, in terms of this point, it is preferable that the phase difference adjusting additive material together with the polymerizable liquid crystal molecule constitutes a copolymer. In addition, it is more preferable that a plurality of polymerizable functional groups is included in one molecule, so that three-dimensional cross-linking can be implemented. According to the phase difference adjusting additive material, the refractive index nz can be adjusted so as to be approximately equal to the values of the refractive indices nx and ny while maintaining the hardness of the phase difference layer 4 and the function as the transparent protective layer. Therefore, an apparent refractive index anisotropy of the phase difference layer 4 can be adjusted so as to be low, so that the optical compensation function of the phase difference layer 4 can be adjusted.

As the phase difference adjusting additive material together with the polymerizable liquid crystal molecule constituting the copolymer, a polymerizable multifunctional acrylate is preferably used. As the polymerizable multifunctional acrylate, dipropylene glycol diacrylate, alkoxy hexanediol diacrylate, tricyclodecane dimethanol diacrylate, alkoxylated aliphatic diacrylate, polyethylene glycol dimethacrylate, 1,4-butanediol dimethacrylate, diethylene glycol dimethacrylate, ethoxylated bisphenol A dimethacrylate, penta erythritol triacrylate, trimethylolpropane tri(metha)acrylate, penta erythritol tetra acrylate, dipenta erythritol penta acrylate, ditrimethylol propane tetra acrylate, ethoxylated (4) penta erythritol tetra acrylate, or the like may be used. As detailed commercial products, a KAYARAD series (manufactured by Nippon Kayaku Co.), a LIGHT ESTER series (manufactured by Kyoeisha Chemical Co., Ltd.), an SR&CD series (manufactured by SARTOMER Co.), an ARONIX series (manufactured by Toagosei co., ltd.), or the like may be more suitably used. As the epoxy acrylate oligomer, a CN series (manufactured by SARTOMER Co.) such as CN115, CN116 and CN118 may be more suitably used. As the reactive epoxy resin, an Epicoat series (manufactured by Japan Epoxy Resins Co., Ltd.) or the like may be more suitably used. As the silica beads, a SNOWTEX series (manufactured by Nissan Chemical Industries, Ltd.) or the like may be more suitably used. In addition, as the barium sulfate, a BARIFINE/BF series (manufactured by Sakai Chemical Industry Co., Ltd.) may be used.

In addition, with respect the formation of the phase difference layer 4, the vertical orientation layer is inserted between the substrate 2 and the phase difference layer 4 in advance, and the phase difference layer 4 is directly laminated on the surface of the vertical orientation layer. This configuration is preferable since the optical axis of the phase difference layer 4 can be oriented more uniformly in the z-axial direction.

The vertical orientation layer may be formed by coating the substrate 2 with the vertical orientation layer compositional solution including constituents constituting the vertical orientation layer through a flexo printing method, a spin coat method, or the like to form a vertical orientation layer formation coated layer and by curing the coated layer. A solution containing polyimide may be exemplified as the vertical orientation layer compositional solution. More specifically, SE-7511 or SE-1211 manufactured by NISSAN CHEMICAL INDUSTRIES, Ltd. or JALS-2021-R2 manufactured by JSR Co. may be exemplified as the vertical orientation layer compositional solution containing polyimide.

It is preferable that the thickness of the vertical orientation layer is in a range of about 100 Å to about 1000 Å. If the thickness of the vertical orientation layer is less than 100 Å, it may be difficult to obtain an effect of homeotropically align the liquid crystal molecules. In addition, if the thickness of the vertical orientation layer is more than 1000 Å, a degree of light scattering due to the vertical orientation layer is increased, so that the light transmittance of the phase difference controlling member may be decreased. Therefore, although the vertical orientation layer is inserted, the phase difference layer 4 can reduce the step difference surface of the substrate 2.

In addition, in the case where the vertical orientation layer has a high water-repellent property or a high oil-repellent property, before the phase difference layer 4 is formed by coating the vertical orientation layer with the liquid crystal material composition, a UV rinsing process or a plasma process may be performed to an extent that the liquid crystal molecules can be homeotropically oriented, and wettability of the surface of the vertical orientation layer that is to be coated with the liquid crystal compositional solution may be increased in advance.

In the phase difference controlling member 1, with respect to the phase difference layer 4 where the uppermost surface is exposed, although the size of the step difference of the surface of the phase difference layer 4 (step difference amount T (for example, T in FIGS. 1, 2 and 4)) is less than 500 nm, it is ideal that a step difference does not occur in the phase difference layer 4 (step difference amount T=0 (zero)).

In the phase difference controlling member 1, in the case where the upwardly protruding convex portion and the downwardly receding concave portion are formed on the phase difference layer 4 located on the uppermost surface thereof and there is a step difference, if there is a planarized or substantially planarized portion between the protruding convex portion and the receding concave portion, the step difference amount T is a value specified as a thickness direction length of the phase difference controlling member 1, and in the protruding convex portion, the step difference amount is a value of difference between the front end portion and the bottom portion. Otherwise, the step difference amount is a value specified as a thickness direction length of the phase difference controlling member 1, and in the receding convex portion, the step difference amount is a value of difference between the edge portion (the portion where the edge is performed) and the bottom portion.

In addition, in the case where there is no planarized or substantially planarized portion between the protruding convex portion and the receding concave portion and the protruding convex portion and the receding concave portion are connected to each other, the step difference amount T is a value specified as a thickness direction length of the phase difference controlling member 1, and the step difference amount is a value of difference between the front end portion of the protruding convex portion and the bottom portion of the receding concave portion.

For example, as shown in FIG. 2, in the case where the phase difference controlling member 1 is configured so that the coloring layer having the black matrix and the color patterns is formed as a base layer and the step difference surface is formed on the surface of the coloring layer, the phase difference layer 4 is configured so that the receding concave portion Ws is formed between planarized or substantially planarized portions Fs. In other words, the receding concave portion Ws exists between the planarized portions Fs where the step difference is negligibly small with respect to the receding concave portion Ws. In this case, the step difference amount T is a value specified as a thickness direction length of the phase difference controlling member 1, and in the receding concave portion Ws, the step difference amount is a value (T in FIG. 2) of difference between the position of the edge portion 9 and the position of the bottom portion 10.

In the phase difference controlling member 1, it is preferable that a step difference does not occur on the surface of the phase difference layer 4. Even if a step difference occurs on the surface of the phase difference layer 4, it is preferable that the value of the step difference amount T is less than 500 nm. In this configuration, the liquid crystal molecules of the driving liquid crystal layer contacting with the phase difference layer 4 cannot be applied with the unexpected orientation due to the step difference of the phase difference layer 4, and large disturbance cannot occur in the orientation characteristic of the driving liquid crystal layer.

In the present invention, the optical axis of the phase difference layer is erected on a plane of which the normal line is in the thickness direction of the phase difference layer. Herein, in the case where x and y axes which are perpendicular, i.e., orthogonally crossed to each other are located in in-plane directions of the phase difference layer and a z axis is located in a direction of normal line of the phase difference layer, if the x-axial, y-axial and z-axial refractive indices of the phase difference layer are set to nx, ny and nz, respectively, the refractive indices nx, ny and nz and a coefficient P with respect to light having a wavelength of 589 nm have the following relationship of Formula A.

In the phase difference layer 4, the coefficient P defined by the following Formula A is in a range of 0.005 or more and 0.04 or less as expressed by the following Formula 1, and the thickness d (nm) of the phase difference layer 4 is 2000 nm or less as expressed by the following Formula 2. In addition, a product of the coefficient P and the thickness (d) of the phase difference layer 4 is in a range of 10 or more and 40 or less as expressed by the following Formula 3:

P=nz−((nx+ny)/2) Formula A;

0.005≦P≦0.04 Formula 1;

d≦2000 Formula 2 and

10≦P×d≦40 Formula 3.

In addition, the thickness (d) of the phase difference layer 4 expressed by Formula 2 and Formula 3 is the thickness (d) of the phase difference layer 4 in the portion corresponding to the pixel when the phase difference controlling member 1 is assembled in the liquid crystal display. In the case where the portion corresponding to the pixel is a substantially planarized surface as viewed macroscopically and where fine unevenness is partially formed, the thickness of the substantially planarized surface is set to the aforementioned thickness d. In addition, in the case where the portion corresponding to the pixel is an overall uneven surface as viewed macroscopically, the maximum value of the thickness of the portion is set to the aforementioned thickness d.

More specifically, in the case where the portion corresponding to the pixel has a protruding convex portion or a downwardly receding concave portion and there is a planarized portion of a substantially planarized portion between the protruding or receding portions, the value of d in the phase difference layer 4 is set to the thickness of the planarized portion in the phase difference layer 4. In the case where the portion corresponding to the pixel has a protruding convex portion and a downwardly receding concave portion and a planarized portion is not perceived, the value of d in the phase difference layer 4 is set to the thickness of the phase difference layer 4 at the position where the maximum thickness is provided or at a position near the position among the predetermined portion where the maximum thickness of the phase difference layer 4 is predicted to exit in the phase difference layer. More specifically, the thickness (d) of the phase difference layer 4 is determined as follows.

First, a predetermined position (phase difference layer thickness determining position (for example, the position denoted by reference numerals Q in FIGS. 2 and 4)) is selected from the in-plane of the step difference surface 8 that is formed as a base of the phase difference layer 4. The phase difference layer thickness determining position Q is selected from the portion corresponding to the portion that causes a phase difference of the light passing through the phase difference controlling member 1. In addition, in the case where there is a planarized portion or a substantially planarized portion between the protruding convex portions or the downwardly receding concave portions on the step difference surface 8, the phase difference layer thickness determining position is selected from the planarized portion or the substantially planarized portion. In addition, the portion corresponding to the portion that causes a phase difference of the light passing through the phase difference controlling member 1 is suitably determined as the portion that is to correspond to the pixel according to the design of the liquid crystal display in which the phase difference controlling member 1 is assembled.

Therefore, the thickness of the portion of the phase difference layer 4 laminated at the selected phase difference layer thickness determining position Q is specified as the thickness (d) of the phase difference layer 4 (for example, reference numeral d in FIGS. 2 and 4).

However, with respect to the phase difference controlling member 1, in the case where the both or one of the protruding portion or the downwardly receding concave portion have a planarized portion or a substantially planarized portion on the in the step difference surface 8, that is, in the case where there are plural types of the planarized portions, the phase difference layer thickness determining position is in a planarized portion among the protruding convex portion and the downwardly receding concave portion and selected from the region of the portion corresponding to the portion that causes a phase difference of the light passing through the phase difference controlling member 1. In addition, in the case where both of the protruding convex portion and the downwardly receding concave portion correspond to the portions that cause the phase difference of the light passing through the phase difference controlling member 1, the phase difference layer thickness determining position Q is selected from the downwardly receding concave portion.

In addition, in general, a plurality of planarized portions or substantially planarized portions including the portions that are predicted to be the positions giving the value of d are selected from the portions of the phase difference layer 4. In addition, the substantially central position (or central position) in each of the portions is selected, and a plurality of the values of thickness of the phase difference layer 4 are obtained by specifying the thickness of the phase difference layer 4 at the positions. The average value thereof is set to the thickness (d) of the phase difference layer 4.

In a detailed example, as shown in FIG. 2, in the case where the phase difference controlling member 1 is configured so that the coloring layer 13 having the black matrix 15 and the color patterns 16, 17 and 18 is formed as a base layer and the step difference surface 8 is formed on the surface of the coloring layer 13, the protruding convex portions S are formed as the color patterns 16, 17 and 18, and the downwardly receding concave portions W are formed as the black matrix 15, so that substantially planarized portions F are formed between the protruding convex portions S in the step difference surface 8. In the example of FIG. 2, although the portions corresponding to the portions where a phase difference occurs in the light passing through the phase difference controlling member 1 corresponds to the portion constructed with the planarized portions F and portions of the protruding convex portion S, the phase difference layer thickness determining positions Q are selected at the central positions of the regions of the substantially planarized portions F. In addition, the thickness of the phase difference layer at the positions Q is set to d.

Herein, although there are three types of color patterns 16, 17 and 18 as the coloring layer 13 shown in FIG. 2, since a light where human eye's sensitivity is high is the light having a wavelength of 550 nm or a wavelength band around the wavelength (that is, green light), strict phase difference control corresponding to the light having the wavelength of 550 nm or a wavelength band around the wavelength is greatly required for the phase difference controlling member 1 including the coloring layer 13. Therefore, preferably, in the case where the phase difference controlling member 1 has the coloring layer 13, the position applied with the thickness (d) of the phase difference layer 4 is allocated with reference to the green color pattern 17 among the color patterns 16, 17 and 18 constituting the coloring layer 13.

In another embodiment of the phase difference controlling member 1 shown in FIG. 4, the protruding convex portions S is formed as a black matrix (15) formation layer, and downwardly receding concave portions W are formed on the surface of the substrate 2. In this configuration, the phase difference layer thickness determining positions Q are portions corresponding to the portions where a phase difference occurs in the light passing through the phase difference controlling member 1. The phase difference layer thickness determining positions are selected from the regions of the downwardly receding concave portions W. In addition, the thickness of the phase difference layer at the position Q is set to d.

In addition, in the phase difference controlling member 1, in the case where the configuration shown in FIG. 1 is provided and the protruding convex portions and the downwardly receding concave portions correspond to the portions corresponding to the portions that generate a phase difference of light passing through the phase difference controlling member 1, the phase difference layer thickness determining positions Q are selected from the downwardly receding concave portions. In FIG. 1, the phase difference layer thickness determining positions Q are selected at the central position of the downwardly receding concave portions, and the thickness (d) of the phase difference layer is determined based on the thickness at the positions.

With respect to the phase difference controlling member 1, if the thickness (d) of the phase difference layer 4 is 2000 nm or less as expressed in Formula 2, it is possible to suppress the problem that the state that the phase difference layer 4 is colored yellowish due to the liquid crystal material composition used to form the phase difference layer 4 may be visually perceived with a non-negligible degree.

In addition, in the phase difference controlling member 1, the thickness (d) of the phase difference layer 4 is in a range satisfying Formula 2, and the coefficient P is in a range satisfying Formulas 1 and 3, so that a suitable phase difference occurs in the light passing through the phase difference layer 4. Accordingly, the phase difference layer 4 is allowed to have an effective optical compensation function.

In addition, as the phase difference layer covering the step difference surface 8 of the phase difference controlling member 1 is configured to be thicker, the value of the step difference amount T over the entire in-plane directions in the portion where the phase difference layer 4 is formed can be set to be smaller. In the example of the phase difference controlling member 1 shown in FIG. 2, in the case where the thickness d (nm) of the phase difference layer 4 is 1000 or more (or substantially 1000 or more), the phase difference layer 4 may be configured so that the value of the step difference amount T is less than 500 nm.

In the phase difference layer 4, the value of the coefficient P is based on the values of the refractive indices nx, ny and nz with respect to the light (sodium D-line) having a wavelength of 589 nm. In addition, the light having a wavelength of 589 nm is used for the following reasons. In other words, in the case where the phase difference controlling member 1 is assembled in the liquid crystal display, since the optical compensation function of the phase difference layer 4 is mainly to effectively suppress the light leakage that is to be perceived by an observer, it is preferable to effectively perform the optical compensation for the light having the wavelength where the human eye's sensitivity of the observer is high in terms of effectively improving the optical compensation function. In general, since the light where the human eye's sensitivity is high is green light having a wavelength of 550 nm or a wavelength band around the wavelength, the phase difference amount of the phase difference layer is set so that the light leakage around the green color can be most effectively suppressed. At this time, a gain as the light having a wavelength near the green wavelength band can be easily obtained, the measurement of the phase difference amount can be relatively easily performed, and there is almost no difference in the refractive index of the light in the wavelength longer than the wavelength of 550 nm. Therefore, the light having the wavelength of 589 nm is employed, and the coefficient P of the phase difference layer 4 is defined with reference to the light.

However, if the refractive index of the light having the wavelength of 589 nm is used as a reference used to set the phase difference layer 4 having the optical compensation function satisfying the aforementioned Formula A and Formula 1, the accurate optical compensation is performed, strictly speaking, only at the wavelength around 589 nm. As a result, the phase difference layer 4 having the optical compensation function of effectively the light leakage of only the green light is obtained. Therefore, when the phase difference layer is observed from the inclined direction, the blue and red color components are increased as the component of the leaking light, so that the leakage of the purplish light is perceived. In this case, according to a change in the observation angle gradually from the front direction toward the inclined direction with respect to the front direction, the light leakage in the front direction is suppressed over the entire range of the visible light, so that the dark display is implemented at an achromatic color. However, according to a change in the observation angle toward the inclined angle, since the leakage of the purplish light occurs, there is a problem in that the color tone is shifted (color shift) from the black color to the purplish color at the dark display. Accordingly, an image as viewed from the front direction and an image as viewed from the inclined direction may be greatly different in terms of the color tone.

Therefore, if a phase difference controlling member 1, where a phase difference layer 4 having an effective optical compensation function of preventing the light leakage with reference to the light having the wavelength of 589 nm is formed, is to be obtained, the color shift may be greatly increased. If a phase difference controlling member, where a phase difference layer 4 having an optical compensation function and preventing the color shift is formed, is to be obtained, the light leakage may not be effectively suppressed. Accordingly, the refractive index of the phase difference layer needs to be determined by taking into consideration a balance of the light leakage and the color shift according to a design of a product in which the phase difference layer is assembled.

Herein, in the case where the phase difference controlling member according to the present invention is assembled in the liquid crystal display, the phase difference controlling member has an optical compensation function of compensating for a phase difference generated by the polarizing plate. In other words, in the liquid crystal display where the phase difference controlling member in which the phase difference layer 4 is formed is assembled, although the polarizing plate is used, since a protective film made of a TAC film (triacetyl cellulose film) is typically attached on the polarizing plate, and since the TAC film generate a phase difference in the light passing through the TAC film, the phase difference layer formed in the phase difference controlling member according to the present invention is to compensate for the phase difference generated by the TAC film. Therefore, the refractive index or thickness of the phase difference layer 4 for having the optical compensation function needs to be determined with reference to the light having a wavelength of 589 nm by taking into consideration a balance of the light leakage and the color shift occurring from the phase difference of the light due to the polarizing plate made of the TAC film.

According to the phase difference controlling member 1 of the present invention, the phase difference layer 4 is formed so that the thickness (d) of the phase difference layer 4 is in a range satisfying Formula 2 and so that the coefficient P is in a range satisfying Formulas 1 and 3. Therefore, even if a phase difference occurs due to the phase difference layer 4 or other members constituting the liquid crystal display in the case where the phase difference controlling member is assembled in the liquid crystal display (particularly, in the case where the phase difference controlling member is assembled in an IPS-LCD), the liquid crystal display can be configured so that the two optical compensation functions of preventing the light leakage and suppressing color shift can be balanced.

More specifically, the coefficient P of the phase difference layer 4 is determined as follows. First, the phase difference controlling member 1 is used, and the thickness (d) of the phase difference layer 4 that is formed at the phase difference layer thickness determining positions on the step difference surface 8 is measured by magnifying and observing the cross section of the phase difference controlling member 1 using an electron microscope (scanning electron microscope JSM-5300, etc., manufactured by Jeol Ltd.). Next, the normal-light refractive index of the phase difference layer 4 (refractive index with respect to normal light) is calculated based on the above-obtained thickness information (the value of d (nm)) of the phase difference layer 4 by using an optical interference type thin-film measurement system (trade name: F20, manufactured by Filmetrics Inc.). Herein, in general, nx=ny, and the normal-light refractive index corresponds to nx and ny.

In addition, the value of phase difference (Rtilt) is measured by irradiating light having a wavelength of 589 nm on the surface of the portions of the phase difference layer 4 which are formed at the phase difference layer thickness determining positions by using a phase difference measurement apparatus (for example, trade name: KOBRA-21ADH, manufactured by Oji Scientific Instruments Co., Ltd.). While changing the angle inclined with respect to the direction of normal line of the phase difference layer 4 (the incident angle with respect to the phase difference layer 4), the above measurement is performed, so that a profile of the phase difference value (Rtilt) (profile a) with the incident angle as a variable is obtained. Herein, although the phase difference layer 4 is in the state that the optical axis (a in FIG. 7) is orientated in the thickness direction of the phase difference layer 4 (in the state that the value θ in FIG. 7 is considered to be zero), by referring to a method or the like disclosed in Journal of Applied Physics, 48, 1783-1792 (1977) with respect to the phase difference layer 4, the profile of the phase difference value with the incident angle as a variable is determined according to an abnormal-light refractive index of the phase difference layer (refractive index with respect to abnormal light).

Therefore, the abnormal-light refractive index corresponding to the profile a can be determined. Herein, the abnormal-light refractive index corresponds to the refractive index in the thickness direction of the phase difference layer 4, that is, the nx of the phase difference layer 4.

The coefficient P is specified based on the obtained refractive indices nx, ny and nz and Formula A.

In the phase difference layer 4, in the case where a plane of which normal line is parallel to the thickness direction of the phase difference layer 4 is considered, the optical axis (a in FIG. 7) of the phase difference layer 4 is erected on the plane. More specifically, the optical axis a is orientated in the thickness direction (substantially in the thickness direction) of the phase difference layer 4.

Herein, the phase difference layer 4 formed by using the liquid crystal material composition is a layer having a function as a positive C plate, and it is ideal that the liquid crystal molecules constituting the phase difference layer 4 are oriented in the state that the longest axis in the ellipse of the each of the liquid crystal molecules is parallel to the thickness direction of the phase difference layer 4. In the case where the liquid crystal molecules constituting the phase difference layer 4 are ideally oriented, that is, in the case where the optical axes of all the liquid crystal molecules constituting the phase difference layer 4 are completely parallel to the thickness direction of the phase difference layer 4, the optical axis a of the phase difference layer 4 is coincident with the thickness direction of the phase difference layer 4 (the inclined angle θ is zero in FIG. 7), the refractive index anisotropy of the phase difference layer 4 is equal to the refractive index anisotropy of individual liquid crystal molecule. However, naturally, it is actually difficult to completely align the optical axes of all the liquid crystal molecules with the thickness direction of the phase difference layer 4. Therefore, in the actual case, since the optical axes of some liquid crystal molecules may be inclined with the thickness direction of the phase difference layer 4, the liquid crystal molecules are oriented with a fluctuation in a certain range. However, although there is a fluctuation in the optical axes of the liquid crystal molecules in this manner, if the fluctuation belongs to the predetermined range, the state that the optical axis a of the phase difference layer 4 is orientated to the thickness direction of the phase difference layer 4 (or the approximate thickness direction) is maintained as the optical axis a is viewed. By taking into consideration this point, it is preferable that the directions of the optical axes of the liquid crystal molecules constituting the phase difference layer 4 exceed a range of 5° in terms of the inclined angle with respect to the thickness direction of the phase difference layer 4.

In the phase difference controlling member 1 according to the present invention, the phase difference layer 4 is laminated to cover the step difference surface 8 that is formed on the uppermost surface by laminating the base layer 5 on the substrate 2. At this time, the uppermost surface of the phase difference controlling member 1 can be planarized by using the phase difference layer 4 in comparison with the step difference surface 8. A degree of the planarization of the uppermost surface may be suitably set according to the design of the phase difference controlling member 1 and the configuration of the phase difference layer 4. In addition, the phase difference layer 4 is provided to the phase difference controlling member 1, and the heat resistance of the phase difference layer 4 is relatively high, so that the heat resistance of the base layer 5 covered with the phase difference layer 4 can be improved. For example, in the case where the base layer 5 is the coloring layer 13, the heat resistance of the coloring layer can be improved by forming the phase difference layer 4. In this case, the phase difference layer 4 can have the function as the transparent protective layer laminated on the surface o the coloring layer 13 in the liquid crystal display. In addition, the phase difference layer 4 may have an optical compensation function as a positive C plate. Therefore, the phase difference layer 4 of the phase difference controlling member 1 has a transparent protective layer function and an optical compensation function.

The phase difference controlling member 1 according to the present invention is manufactured as follows.

The step difference surface 8 is formed on the uppermost surface by laminating the base layer 5 on the substrate 2, and the aforementioned adjusted liquid crystal material composition is coated on the step difference surface 8, so that the liquid crystal coated layer is produced.

As a method of coating the surface (step difference surface) of the base layer on the substrate 2 with the liquid crystal material composition, there are suitably used various printing method such as a die coat method, a bar coat method, and a slide coat method, a roll coat method, and a slit coat method, a method such as a spin coat method, or a combination thereof.

In addition, if the liquid crystal material composition is coated on the step difference surface of the base layer 5 on the substrate 2, the laminated structure of the substrate 2, the base layer 5, and the liquid crystal coated layer is subjected to drying. The drying is performed in the depressed state. Alternatively, the drying may be performed at the atmospheric pressure. The naturally driving at the atmospheric pressure is preferable because the orientation can be uniformly applied to the liquid crystal molecules. Next, the phase difference layer 4 is formed by polymerizing the liquid crystal molecules included in the liquid crystal coated layer, so that the phase difference controlling member 1 can be obtained.

In addition, the present invention is not limited to the case where the phase difference layer 4 is formed on the entire surface of the step difference surface 8, but the phase difference layer may be partially formed thereon.

As a detailed method of partially forming the phase difference layer 4, there may be exemplified a method of pattering the substrate 2 by using various printing methods or a photolithography method. Therefore, a predetermined region such as a region where pixels are formed in the phase difference controlling member 1 is defined, and the phase difference layer 4 can be formed in a predetermined pattern on the targeted region.

In this manner, if needed, a phase difference controlling member 1 where the phase difference layer 4 having an optical compensation function is formed may be manufactured.

In addition, in the phase difference controlling member 1 according to the present invention, it is preferable that, after the phase difference layer 4 formed through the polymerization of the liquid crystal molecules included in the liquid crystal coated layer, a process of heating the phase difference layer 4 including the polymerized liquid crystal molecules (refer to as a heating process after polymerization) is performed to improve hardness of the phase difference layer 4. However, in the case where the heating process after the polymerization is performed, since the substrate 2 needs to have heat resistance, it is preferable that a glass substrate or the like having heat resistance is used as a substrate formation material constituting the substrate 2.

When the heating process after the polymerization is performed, the heating temperature of the phase difference layer 4 is in a range of 150 to 260° C., preferably, in a range of 200 to 250° C. in terms that the phase difference layer 4 after the heating process after the polymerization is to effectively hardened in comparison with that before the heating process after the polymerization. The time for performing the heating process after the polymerization is in a range of 5 to 90 minutes, preferably, in a range of 15 to 30 minutes in the same terms as the above terms with respect to the heating temperature at the time of performing the heating process after the polymerization. In addition, if the heating temperature exceeds 260° C. or the heating time exceeds 90 minutes, the hardness and strength of the phase difference layer 4 increases, but the phase difference layer 4 may be changed into a strongly yellowish state. On the other hand, if the heating temperature is lower than 150° C. or the heating time is lower than 5 minutes, a sufficient strength and hardness may be not be obtained.

Next, the phase difference layer 4 is heated, and after, the temperature thereof is decreased.

More specifically, the heating process after the polymerization is performed by loading the substrate 2 where the phase difference layer 4 is formed on a baking unit such as an oven unit and baking the substrate at a high temperature at the atmospheric pressure in the air ambience. Alternatively, a method using infrared light irradiation may be performed.

In addition, when the heating process after the polymerization is performed, it is preferable that the temperature increasing of the phase difference layer 4 and the temperature decreasing after the heating process are gradually performed.

Next, a liquid crystal display using the phase difference controlling member 1 according to the present invention is described.

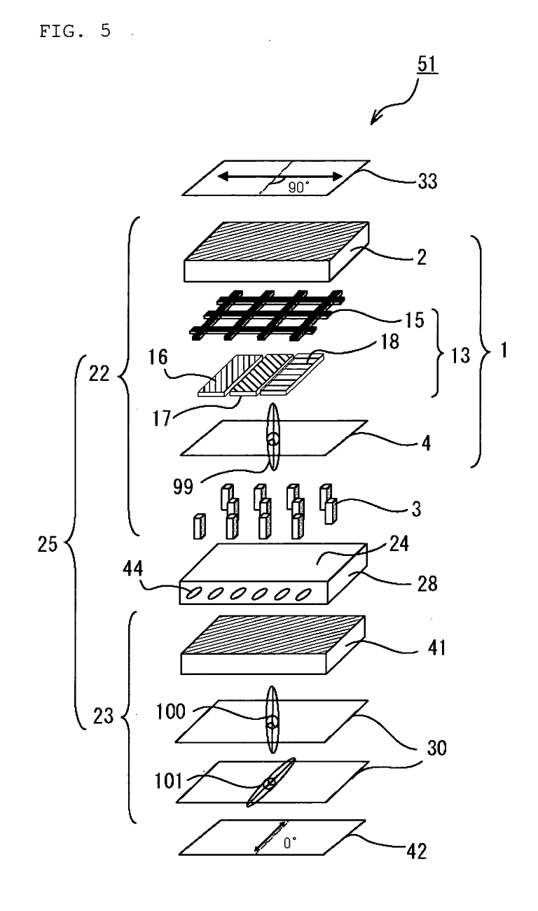

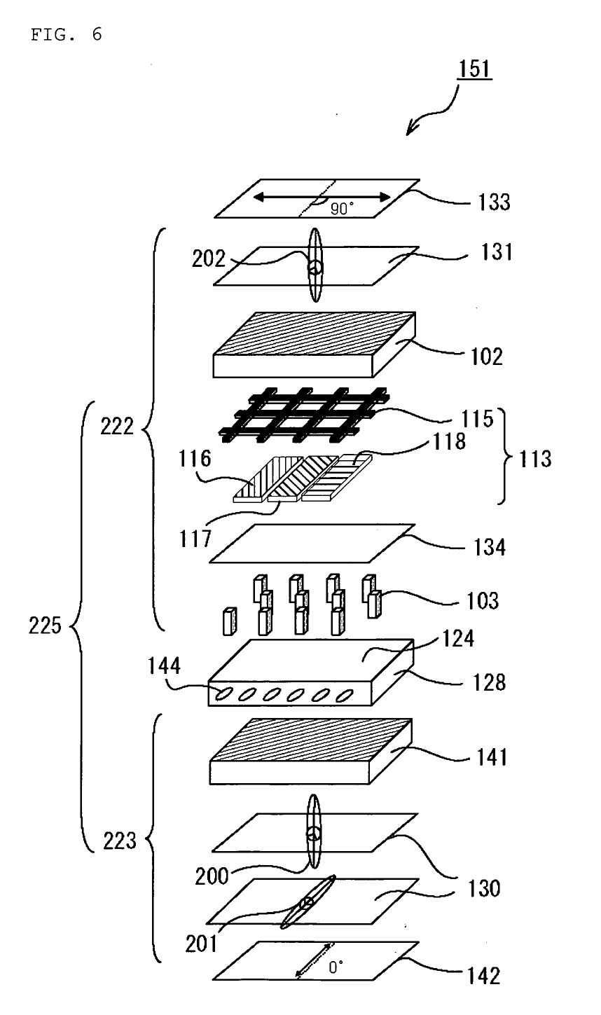

In the embodiment of the present invention shown in FIG. 5, there is provided an IPS mode liquid crystal display, where the phase difference controlling member 1 in which the coloring layer 13 is formed as the base layer 5 is assembled.

In the liquid crystal display 51 according to the present invention, as shown in FIG. 5, a substrate structure 25 is constructed with the substrate portion 23 having the TFT array substrate and the opposite substrate portion 22 that is disposed to face the substrate portion 23, and the driving liquid crystal layer 28 is formed by inserting and sealing the liquid crystal composition 24 for driving the liquid crystal display, where the orientation of the liquid crystal molecules are changed according to a change in the eclectic field, between a pair of the substrate portions 22 and 23. At the lower position of the substrate portion 23, a backlight (not shown) that irradiates light on the substrate portion 23 is disposed.

In the opposite substrate portion 22, the coloring layer 13 having the black matrix 15 and color patterns 16, 17 and 18 are disposed on the substrate 2. The step difference surface is formed on the surface of the laminated structure that is formed by laminating the coloring layer 13 on the substrate 2, and the phase difference layer 4 is laminated on the step difference surface.

In addition, a plurality of pillars 3 are formed on the phase difference layer 4 by using a well-known method such as a photolithography method, so that the pillars are distributed on the phase difference layer 4. The pillars 3 are disposed to the portions that do not correspond to the pixels in the coloring layer 13, that is, the pixel non-formed portions.

The pillar 3 is made of a resin material having a light curable photosensitivity such as an acrylic series resin material containing a multifunctional acrylate, and an amide series or ester series polymer.

The linearly polarizing plate 33 is disposed on the surface of the opposite side of the surface of the substrate 2 where the coloring layer 13 is to be formed.

In the substrate portion 23, although not shown, TFTs constituting a driving circuit that performs switch driving for voltage application to the liquid crystal 44 of the driving liquid crystal layer 28 and liquid crystal driving electrodes for controlling the loaded amount of the voltage to the driving liquid crystal layer 28 are disposed on the surface of the in-cell side of the transparent substrate 41 (side contacting with the driving liquid crystal layer 28). The liquid crystal driving electrode generates electric field in the in-plane direction of the driving liquid crystal layer 28, so that the orientation of the liquid crystals 44 in the in-plane direction of the driving liquid crystal layer 28 is changed.

Distal end portions of a plurality of the pillars 3 are configured to abut on the surface of the side contacting with the driving liquid crystal layer 28 of the substrate 41. In addition, the linearly polarizing plate 42 is disposed to the lower portion of the surface of the opposite side of the side contacting with the driving liquid crystal layer 28 of the substrate 41.

The linearly polarizing plate 33 of the opposite substrate portion 22 and the linearly polarizing plate 42 of the substrate portion 23 are disposed so that the light-transmitting axes thereof are perpendicular to each other. The light-transmitting axes of the linearly polarizing plates 33 and 42 are indicated by arrows in FIG. 5.

The liquid crystal display 51 has a layer structure where the coloring layer 13 and the phase difference layer 4 as well as the substrate 2 are laminated on the opposite substrate portion 22. The layer structure constitutes the phase difference controlling member 1 according to the present invention. In other words, the phase difference controlling member 1 is assembled in the liquid crystal display 51.

In the liquid crystal display 51, if needed, the phase difference films 30 and 30 are disposed at positions between the substrate 41 and the linearly polarizing plate 42 in the substrate portion 23. In the embodiment shown in FIG. 5, as the liquid crystal display 51, there are a liquid crystal display where a phase difference controlling member 1 where the phase difference layer 4 is formed as a layer having an optical compensation function as a positive C plate is assembled, a liquid crystal display where a phase difference film 30 having an optical compensation function as a positive A plate is assembled, a liquid crystal display where a phase difference film 30 having an optical compensation function as a positive C plate is assembled, and the like. Herein, the phase difference layer 4 is assembled in the liquid crystal display 51 as a layer having an optical compensation function corresponding to a positive C plate that optically compensates for the phase difference of light generated when the light passes through the polarizing plate. In addition, in the case where the viewing angle is changed, the phase difference films 30 and 30 are assembled as a phase difference film for preventing the light leakage occurring due to a change in an apparent axial angle of a cross-Nicole polarizing plate. In addition, in FIG. 5, the birefringent characteristic determining the optical compensation function of the phase difference layer 4 or the phase difference film 30 is expressed by each of the refractive index ellipses 99, 100, and 101.

In the case where a positive A plate or a positive C plate having an optical compensation function is used as the phase difference film 30 and 30, elements having other functions may be combined thereto.

Although the embodiment of the present invention is described in the case where the liquid crystal display is of the IPS mode, the present invention is not limited thereto. For example, the phase difference controlling member 1 may be assembled in other modes of liquid crystal display such as an MVA mode or an OCB mode (optically compensated birefringence mode).

### EMBODIMENT

### First Embodiment

As a substrate, a glass substrate (trade name: 1737 glass, manufactured by Corning Corp.) is prepared, and a black matrix is formed as a base layer on the organic substrate by using a coloring material dispersed solution. The formation of the black matrix is performed as follows.

### [Formation of Black Matrix]

As the coloring material dispersed solution for the black matrix (BM), a pigment dispersive photoresist is used. The pigment dispersive photoresist is obtained by using a pigment as a coloring material, adding beads to a dispersed solution composition (containing a pigment, a dispersing agent, and a solvent), dispersing the resulting product for 3 hours by using a dispersing apparatus, and after that, mixing the dispersed solution, from which the beads are removed, and a clear resist composition (containing a polymer, a monomer, an additive, an initiator, and a solvent). The obtained pigment dispersive photoresist has composition as follows. In addition, a paint shaker (manufactured by Asada Iron Works, Co., Ltd.) is used as the dispersing apparatus.

(Black Matrix Photoresist)

| | |
|---|---|
| black pigment | 14.0 parts by weight |
| (trade name: TM Black #9550, manufactured by | |
| Dinah Seika Industry Co., Ltd) | |
| dispersing agent | 1.2 parts by weight |
| (trade name: Disperbyk111, manufactured by Byk | |
| Chemie Corp.) | |
| polymer | 2.8 parts by weight |
| (trade name: VR60, manufactured by Showa | |
| Highpolymer Co., Ltd) | |
| monomer | 3.5 parts by weight |
| (trade name: SR399, manufactured by | |
| SARTOMER Co.) | |
| additive | 0.7 parts by weight |
| (trade name: L-20, manufactured by Soken | |
| Chemical Co., Ltd.) | |
| initiator | 1.6 parts by weight |
| (2-benzyl-2-dimethyl amino-1-(4-morpholino | |
| phenyl)-butanone-1) | |
| initiator | 0.3 parts by weight |
| (4,4′-diethyl amino benzophenone) | |
| initiator | 0.1 parts by weight |
| (2,4-diethyl thioxanthone) | |
| solvent | 75.8 parts by weight |
| (ethylene glycol mono butyl ether) | |

The produced BM photoresist is coated on an upper surface of the glass substrate that is subject to a rinsing process by using a spin coat method; a pre-baking (pre-baking) process is performed at 90° C. for 3 minutes; a yellow process (100 mJ/cm²) is performed by using a mask having a predetermined pattern; a spray developing process is performed for 60 seconds by using a 0.05% KOH aqueous solution; and a post-baking (baking) process is performed at 200° C. for 30 minutes, so that the BM-formed glass substrate (BM-formed substrate) is produced. The BM is formed with a thickness of 1.2 μm in a vertical-horizontal lattice shaped pattern as viewed from a plane.

It is verified that, due to the formation of the BM, step differences are formed with the BM having the convex portions that protrude from the surface of the glass substrate and the exposed portions of the glass substrate that recedes relatively downwards with respect to the portions where the BM is formed, so that a step difference surface is formed on the uppermost surface.

After the glass substrate having the BM, where the step difference surface is formed, as the base layer is obtained, the glass substrate is loaded on a spin coater (trade name: 1H-360S, manufactured by MIKASA Co., Ltd.), and a liquid crystal material composition that is adjusted as follows is spin-coated on the surface (step difference surface) of the BM, so that the liquid crystal material composition 3 (mL) is coated on the substrate. As a result, a liquid crystal coated layer is produced. In addition, in the example, the liquid crystal coated layer is formed on the BM (step difference surface).

### [Production of Liquid Crystal Material Composition]

The liquid crystal material composition having the following compositions is adjusted by mixing a polymerizable liquid crystal molecule, a photo-polymerization initiator, a silane coupling agent, and a solvent expressed by the following compounds (a) to (d).

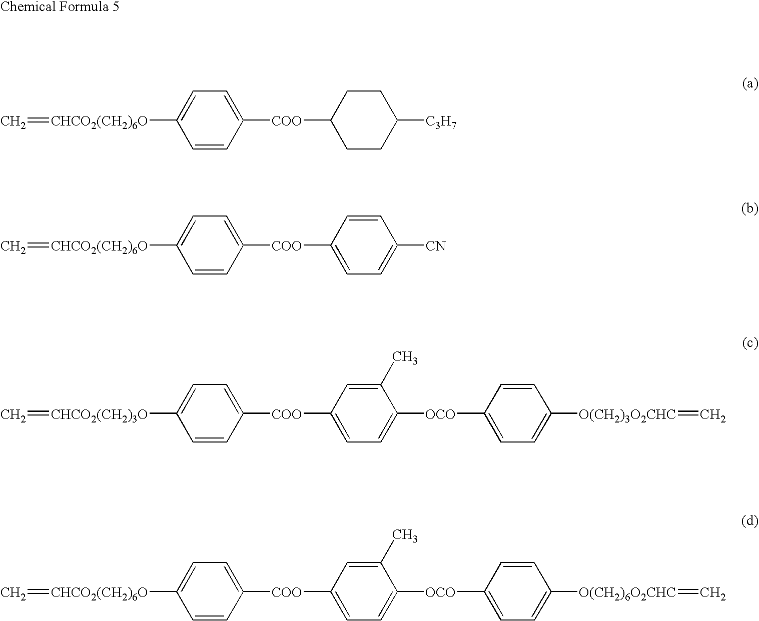

<Composition of Liquid Crystal Material Composition>
compound (a): 8.3 parts by weight
compound (b): 4.7 parts by weight
compound (c): 5.4 parts by weight
compound (d): 5.4 parts by weight
photo-polymerization initiator: 1.3 parts by weight (trade name: IRUGACURE 907, manufactured by CHIBA SPECIALTY CHEMICALS Co.)
silane coupling agent: 0.05 parts by weight (amine group containing silane coupling agent (trade name: TSL-8331, manufactured by GE Toshiba Silicones Co., Ltd.))
solvent: 75.0 parts by weight
(chlorobenzene)

### [Formation of Liquid Crystal Phase State of Liquid Crystals Included in Liquid Crystal Coated Layer]

The substrate where the liquid crystal coated layer is formed is heated on a hot plate at 100° C. for 5 minutes, so that the solvent is removed and so that the liquid crystal molecules included in the liquid crystal coated layer is phase-transitioned into a liquid crystal phase. Verification of the transition into the liquid crystal phase is performed by visually checking that the liquid crystal coated layer is changed from a white turbid state to a transparent state. In addition, at this time, the liquid crystal molecules are allowed to have a homeotropic orientation characteristic.

### [Cross-Linking Polymerization Reaction of Liquid Crystal Molecules]

Next, the temperature of the glass substrate where the liquid crystal coated layer is formed is set to 60° C., and in a nitrogen ambience, ultraviolet light (365 nm) having a power of 500 mJ/cm² is irradiated on the entire surface of the transparent state liquid crystal coated layer by using a ultraviolet light irradiating apparatus (trade name: TOSCURE751, manufactured by Harrison Toshiba Lighting Co.). The glass substrate is baked at a high temperature by loading the glass substrate on the hot plate at 240° C. for one hour, so that the liquid crystal molecules included in the liquid crystal coated layer are subject to cross-linking polymerization reaction. Therefore, the liquid crystal molecules are fixed in the state that the liquid crystal molecules have the orientation characteristic, so that the liquid crystal coated layer becomes the phase difference layer. As a result, the phase difference controlling member where the phase difference layer is laminated on the base layer can be obtained.

The thickness (d) of the phase difference layer of the phase difference controlling member is measured. When the thickness of the phase difference layer is measured, the center of the one partition among the partitions that are located on the surface of the substrate and formed in the lattice shape as viewed in plane by the black matrix is selected as the phase difference layer thickness determining position on the step difference surface.

With respect to the portion of the phase difference layer which is formed at the phase difference thickness determining position of the step difference surface, the thickness of the phase difference layer is measured by using an electron microscope (scanning electron microscope JSM-5300, manufactured by Jeol Ltd.), so that the value of the thickness (d) of the phase difference layer is obtained. The thickness (d) of the phase difference layer is 1.02 μm (1020 nm).

In addition, by using the phase difference controlling member, the refractive indices nx, ny and nz of the phase difference layer are measured, and a coefficient P is derived as follows.

First, by using the phase difference controlling member, the refractive indices nx and ny of the phase difference layer are obtained by using the thickness information (value of d) that is obtained by using an optical interference type thin-film measurement system (trade name: F20, manufactured by Filmetrics Inc.). In addition, light having a wavelength 589 nm is irradiated on the surface of the portion of the phase difference layer 4 which is formed at the phase difference layer thickness determining position by using a phase difference measurement apparatus (trade name: KOBRA-21ADH, manufactured by Oji Scientific Instruments Co., Ltd.), so that a profile of the phase difference value (Rtilt) with the incident angle of light as a variable is obtained. The refractive index nz of the phase difference controlling member is determined based on the profile. Next, the coefficient P of the phase difference layer of the phase difference controlling member is calculated based on the refractive indices nx, ny and nz. The value of P is determined to be 0.03. Accordingly, the phase difference amount (Rth) in the thickness direction of the phase difference controlling member is 30.6 nm, so that it is verified that the phase difference amount is an effective phase difference amount (10≦Rth≦40) as a positive C plate that exerts an optical compensation function with respect to the phase difference generated by the polarizing plate.

The step difference amount which is formed on the surface of the phase difference layer that is the uppermost surface of the phase difference controlling member is determined by using the phase difference controlling member and measuring a profile having a cross-sectional shape in the thickness of the phase difference controlling member (cross-sectional profile). Measurement of the cross-sectional profile is performed through observation using an electron microscope (scanning electron microscope JSM-5300, manufactured by Jeol Ltd.). It is verified that the step difference amount of the phase difference controlling member is less than 500 nm.

A liquid crystal display in which the phase difference controlling member is assembled is produced, and it is checked whether or not there is an irregularity in the orientation of the driving liquid crystals and whether or not the optical compensation is suitably performed. The checking is determined based on light leakage when the liquid crystal display is in the dark display state.

### [Measurement of Light Leakage]

<Production of Liquid Crystal Display]

First, on the surface of the phase difference layer of the phase difference controlling member, predetermined positions of the non-pixel portions are set as pillar formation predicted positions as viewed in a plane, and pillars are disposed at the pillar formation predicted positions. As the pillar, NN770 manufactured by JSR Co. is used.

Next, as the orientation layer composition constituting a horizontal orientation layer that horizontally aligns driving liquid crystal molecules sealed in the liquid crystal display, AL1254 (manufactured by JSR Co.) is prepared. The orientation layer composition is coated so as to cover the phase difference layer and the pillars of the phase difference controlling member by using a flexo printing method, so that a coated layer is obtained. The coated layer is baked at a high temperature, and a rubbing process is preformed on the surface of the coated layer by using a rayon rubbing cloth, so that the coated layer becomes a horizontal orientation layer (thickness: 500 Å).

Next, a glass substrate (TFT array substrate) where TFT and electrodes are disposed to each pixel on the surface thereof is prepared, and similarly to the phase difference controlling member, the horizontal orientation layer is formed on the entire surface of the TFT formation surface of the glass substrate.

With respect to the phase difference controlling member where the horizontal orientation layer is formed and the TFT array substrate where the horizontal orientation layer, the TFTs, and the electrodes are formed, the horizontal orientation layer formation surface of the phase difference controlling member and the horizontal orientation layer formation surface of the TFT array substrate are allowed to face each other; the gap between the phase difference controlling member and the facing TFT array substrate is sealed along the circumferential positions of the phase difference controlling member and the facing TFT array substrate by using an epoxy resin as a sealing member; the phase difference controlling member and the facing TFT array substrate are adhered to each other by exerting a pressure of 0.3 kg/m² at 150° C. In addition, the driving liquid crystal layer is formed by inserting and sealing the driving liquid crystals (trade name: ZLI4792, manufactured by Merc Corp.), of which the orientation is changed according to a change in the electric field, in a space between the phase difference controlling member and the facing TFT array substrate, so that one body structure (liquid crystal cell) is obtained. Next, at the thickness direction outside positions of the liquid crystal cell, as a phase difference films that performs optical compensation for a change in an apparent axial angle of a cross-Nicole polarizing plate due to an increase in a viewing angle, an A plate and a C plate are adhered to the side of the TFT array substrate. Next, two sheets of the polarizing plates are inserted between the liquid crystal cell and the phase difference film, and the light-transmitting axes thereof are disposed to be perpendicular to each other, so that the liquid crystal display is produced. The liquid crystal display has a structure where the driving liquid crystal layer is formed between a pair of substrates, that is, the substrate (opposite substrate) in which the phase difference controlling member is assembled and the TFT array substrate in which the TFTs and the electrodes are disposed.

<Checking of Irregularity in Orientation>

By irradiating light on the obtained liquid crystal display from the outer position of the side of the TFT array substrate and allowing the liquid crystal display screen to be in the dark display state, the state of light leakage of the liquid crystal display screen is checked by using a microscope.

The light leakage is not observed over the entire region of pixels constituting the liquid crystal display screen, and a good black display is obtained. Therefore, it is determined that the driving liquid crystal molecules have uniform one-axis orientation.

<Measurement of Light Leakage>

Next, by comparing a liquid crystal display screen state in the case where the liquid crystal display screen is viewed from the front direction of the surface of the opposite substrate with a liquid crystal display screen state in the case where the liquid crystal display screen is viewed from a direction inclined from the front direction as an azimuthal angle direction that is the center between the light-transmitting axes of the pair of polarizing plates, it is determined whether or not the light leakage is at a troublemaking level where the light leakage is immediately perceived by an observer. Next, in the case where the observer determines that the light leakage is not at the troublemaking level, the liquid crystal display is determined as a good liquid crystal display of which the light leakage is suppressed. In the case where the observer determines that the light leakage is at the troublemaking level, the liquid crystal display is determined as a defective liquid crystal display of which the light leakage is not sufficiently suppressed.

In the liquid crystal display using the phase difference controlling member obtained according to the first embodiment, neither the irregularity of the orientation nor the light leakage is not perceived, so that the liquid crystal display is determined as a good liquid crystal display. In addition, it is verified that the phase difference controlling member has a good optical compensation function.

### Second Embodiment

A phase difference adjusting additive material containing liquid crystal material composition that is obtained by adding 3.6 parts by weight of a polymerizable multifunctional acrylate (penta erythritol triacrylate) as a phase difference adjusting additive material to the liquid crystal material composition used in the first embodiment is adjusted. The phase difference adjusting additive material containing liquid crystal material composition is coated on the “glass substrate where the BM is formed as the base layer” similarly to the first embodiment, so that the liquid crystal coated layer is formed. The glass substrate where the liquid crystal coated layer is formed is maintained at 40° C., and similarly to the first embodiment, ultraviolet light is irradiated on the liquid crystal coated layer, so that the phase difference layer is formed. Other configurations are the same as those of the first embodiment. As a result, the phase difference controlling member is obtained.

With respect to the phase difference layer of the phase difference controlling member, the thickness (d) is 1.25 μm (1250 nm), and the coefficient P is 0.020. Accordingly, the phase difference amount (Rth) in the thickness direction of the phase difference controlling member is 25.0 nm, so that it is verified that the phase difference amount is an effective phase difference amount (10≦Rth≦40) as a positive C plate that exerts an optical compensation function. In addition, it is verified that the step difference amount of the phase difference controlling member is less than 500 nm.

Similarly to the first embodiment, a liquid crystal display is produced by using the phase difference controlling member. Similarly to the first embodiment, goodness or defectiveness thereof is evaluated. In the liquid crystal display using the phase difference controlling member, neither the irregularity of the orientation nor the light leakage is perceived, so that the liquid crystal display is evaluated as a good liquid crystal display. It is verified that the phase difference controlling member has a good optical compensation function.

### Comparative Example 1

A liquid crystal material composition used in the first embodiment is coated on the base layer that is formed similarly to the first embodiment, so that the liquid crystal coated layer is formed. The glass substrate where the liquid crystal coated layer is formed is maintained at 30° C., and similarly to the first embodiment, ultraviolet light is irradiated on the liquid crystal coated layer, so that the phase difference layer is formed. Other configurations are the same as those of the first embodiment. As a result, a member where a phase difference layer is formed on the substrate (comparative member 1) is obtained.

With respect to the phase difference layer of the comparative member 1, the thickness (d) is 0.900 μm (900 nm), and the coefficient P is 0.072. Accordingly, the phase difference amount (Rth) in the thickness of the phase difference layer is 64.8 nm, so that it is verified that the phase difference amount deviates from an effective phase difference amount (10≦Rth≦40) as a positive C plate that exerts an optical compensation function. In addition, in the comparative member 1, it is checked that there is a portion where the step difference amount T of the phase difference layer is 600 nm, that is a portion where the step difference amount is 500 nm or more.

In addition, similarly to the first embodiment, a liquid crystal display is produced by using the comparative member 1. Similarly to the first embodiment, goodness or defectiveness thereof is evaluated.

In the liquid crystal display where the comparative member 1 is assembled, the step differences generated due to the coloring layer are not suppressed by the lamination of the phase difference layer. In addition, the irregularity in orientation is perceived, so that the liquid crystal display is evaluated as a defective liquid crystal display. In addition, it is verified that the phase difference controlling member does not have an effective transparent protective layer function. In addition, the light leakage is perceived, so that the liquid crystal display is evaluated as a defective liquid crystal display in terms of the light leakage. Therefore, the phase difference controlling member does not have a sufficient optical compensation function.

### Third Embodiment

As a substrate, a glass substrate (trade name: 1737 glass, manufactured by Corning Corp.) is prepared. A coloring layer having a black matrix and color patterns are formed as a base layer on the glass substrate. Other configurations are the same as those of the first embodiment. As a result, a phase difference controlling member is obtained.

The coloring layer is formed on the glass substrate as follows.

### [Formation of Coloring Layer]

First, similarly to the first embodiment, a black matrix is formed on the surface of the glass substrate by using a coloring material dispersed solution, so that the BM-formed glass substrate (BM-formed substrate) is produced.

<Adjustment of Coloring Material Dispersed Solution Used to Form Color Patterns>

A coloring material dispersed solution for red (R), green (G) and blue (B) color patterns is adjusted. As the coloring material dispersed solution for the red (R), green (G) and blue (B) color patterns, a pigment dispersive photoresist is used.

The adjustment of the pigment dispersive photoresist for the color patterns is performed similarly to the adjustment of the BM photoresist according to the first embodiment. In other words, the pigment dispersive photoresist is obtained by adding beads to a dispersed solution composition (containing a pigment, a dispersing agent, and a solvent), dispersing the resulting product for 3 hours by using a dispersing apparatus (paint shaker (manufactured by Asada Iron Works, Co., Ltd.)), and after that, mixing the dispersed solution, from which the beads are removed, and a clear resist composition (containing a polymer, a monomer, an additive, an initiator, and a solvent). In addition, the pigment dispersive photoresist for each of the color patterns has composition as follows.

(Pigment Dispersive Photoresist for Red (R) Color
Pattern)

| | |
|---|---|
| red pigment | 4.8 parts by weight |
| (C.I.PR254 (trade name: Chromophthal DPP | |
| Red BP, manufactured by CHIBA | |
| SPECIALTY CHEMICALS Co.)) | |
| yellow pigment | 1.2 parts by weight |
| (C.I.PY139 (trade name: Paliotol Yellow D1819, | |
| manufactured by BASF Corp.)) | |
| dispersing agent | 3.0 parts by weight |
| (trade name: SOLSPERS 24000, manufactured by | |
| ZENECA Co.) | |
| monomer | 4.0 parts by weight |
| (trade name: SR399, manufactured by | |
| SARTOMER Co.) | |
| polymer 1 | 5.0 parts by weight |
| initiator | 1.4 parts by weight |
| (trade name: IRUGACURE 907, manufactured by | |
| CHIBAGAIGI Corp.) | |
| initiator | 0.6 parts by weight |
| (2,2′-bis(o-chloro phenyl)-4,5,4′,5′-tetra phenyl- | |
| 1,2′-biimidazole) | |
| solvent | 80.0 parts by weight |
| (propylene glycol mono methyl ether acetate) | |

(Pigment Dispersive Photoresist for Green (G) Color
Pattern)

| | |
|---|---|
| green pigment | 3.7 parts by weight |
| (C.I.PG7 (trade name: Seika Fast Green 5316P, | |
| manufactured by Dainichi Seika Industry | |
| Co., Ltd.)) | |
| yellow pigment | 2.3 parts by weight |
| (C.I.PY139 (trade name: Paliotol Yellow D1819, | |
| manufactured by BASF Corp.)) | |
| dispersing agent | 3.0 parts by weight |
| (trade name: SOLSPERS 24000, manufactured by | |
| ZENECA Co.) | |
| monomer | 4.0 parts by weight |
| (trade name: SR399, manufactured by | |
| SARTOMER Co.) | |
| polymer 1 | 5.0 parts by weight |
| initiator | 1.4 parts by weight |
| (trade name: IRUGACURE 907, manufactured by | |
| CHIBAGAIGI Corp.) | |
| initiator | 0.6 parts by weight |
| (2,2′-bis(o-chloro phenyl)-4,5,4′,5′-tetra phenyl- | |
| 1,2′-biimidazole) | |
| solvent | 80.0 parts by weight |
| (propylene glycol mono methyl ether acetate) | |

(Pigment Dispersive Photoresist for Blue (B) Color
Pattern)

| | |
|---|---|
| blue pigment | 4.6 parts by weight |
| (C.I.PB15:6 (trade name: Heliogen Blue L6700F, | |
| manufactured by BASF Corp.)) | |
| violet Pigment | 1.4 parts by weight |
| (C.I.PV23 (trade name: Hostaperm RL-NF, | |
| manufactured by Clariant Co., Ltd.)) | |
| pigment derivative | 0.6 parts by weight |
| (trade name: SOLSPERS 12000, manufactured by | |
| ZENECA Co.) | |
| dispersing agent | 2.4 parts by weight |
| (trade name: SOLSPERS 24000, manufactured by | |
| ZENECA Co.) | |
| monomer | 4.0 parts by weight |
| (trade name: SR399, manufactured by | |
| SARTOMER Co.) | |
| polymer 1 | 5.0 parts by weight |
| initiator | 1.4 parts by weight |
| (trade name: IRUGACURE 907, manufactured by | |
| CHIBAGAIGI Corp.) | |
| initiator | 0.6 parts by weight |
| (2,2′-bis(o-chloro phenyl)-4,5,4′,5′-tetra phenyl- | |
| 1,2′-biimidazole) | |
| solvent | 80.0 parts by weight |
| (propylene glycol mono methyl ether acetate) | |

The polymer 1 is obtained by adding 16.9 mole % 2-methacryloyloxy ethyl isocyanate to 100 mole % copolymer having a molar ratio of benzyl methacrylate:styrene:acrylic acid:2-hydroxy ethyl methacrylate=15.6:37.0:30.5:16.9. The polymer 1 has a weight-average molecular weight of 42500.

<Formation of Coloring Layer>

The adjusted red (R) pigment dispersive photoresist is coated at the positions corresponding to the red color pattern on the BM-formed substrate by using a spin coat method in advance. A pre-baking process is performed at 80° C. for 3 minutes, and a UV exposure process (300 mJ/cm²) is performed by using a predetermined coloring pattern photomask corresponding to each of the color patterns. In addition, a spray developing process is performed for 60 seconds by using a 0.1% KOH aqueous solution, and after that, a post-baking process is performed at 200° C. for 60 minutes, so that the red (R) color patterns having a thickness of 1.3 μm are formed in a strip shape at predetermined positions on the BM array pattern. In addition, with respect to the thickness of the color pattern, a thickness of the central portion of the display pixel (central portion of a substantially planarized portion) is measured. At this time, the color pattern is formed so that the long direction of the strip shape is parallel to the pattern extending in the one direction among the patterns of the photoresist extending in two (vertical and horizontal) directions in the lattice shaped pattern of the BM. In addition, the edge portion in the long direction of the strip shaped color pattern among the color patterns is configured to overlap with the edge portion in the long direction of the pattern extending in the one direction of the black matrix parallel to the color pattern, so that the portion where the color pattern and the black matrix are partially overlapped with each other is formed as an overlapped portion.

Sequentially, the green (G) color pattern (thickness: 1.2 μm) and the blue (B) color pattern (thickness: 1.2 μm) are formed by using the same method as the pattern forming method for the red (R) color pattern. With respect to the thickness of the color patterns, similarly to the red color pattern, a thickness of the central portion of the display pixel (central portion of a substantially planarized portion) is measured.

In this manner, the coloring layer having the BM and the red, green, and blue color patterns are formed on the glass substrate. In the coloring layer, gap regions are formed by separating adjacent color patterns so that the adjacent color patterns are not overlapped with each other. Therefore, the patterns are formed so that portions of the black matrix are exposed through the gap regions.

Due to the formation of the coloring layer, step differences are formed by the adjacent color patterns and the black matrix exposed through the gap regions between the adjacent color patterns, so that it is verified that a step difference surface is formed on the uppermost surface of the coloring layer.

With respect to the glass substrate having the coloring layer, the step differences of the step difference surface formed on the uppermost surface thereof are identified based on a cross-sectional profile of the phase difference controlling member that is measured by using an electron microscope (scanning electron microscope JSM-5300, manufactured by Jeol Ltd.). According to the measurement result, with respect to a size of the step difference between the region corresponding to the overlapped portion in the color pattern (the region of the protruding convex portion) and the portion of the black matrix exposed through the gap region between the color patterns (downwardly receding concave portion), the maximum size is measured at the step difference formed by the front position of the overlapped portion in the red color pattern and the bottom position of the downwardly receding concave portion, and more specifically, the size is 800 nm.

In this manner, after the glass substrate having the coloring layer where the step difference surface is formed is obtained, similarly to the first embodiment a phase difference layer is laminated on the coloring layer, so that a phase difference controlling member is obtained.

With respect to the phase difference layer of the obtained phase difference controlling member, the thickness (d) is 1.100 μm (1100 nm), and the coefficient P is 0.031. In addition, when the thickness (d) is determined, the center of the display pixel of the green (G) color pattern is selected as the phase difference layer thickness determining position.

As a result, the phase difference amount (Rth) in the thickness of the phase difference layer of the phase difference controlling member 34.1 nm, so that it is verified that the phase difference amount is an effective phase difference amount (10≦Rth≦40) as a positive C plate that exerts an optical compensation function with respect to the phase difference generated by the polarizing plate. In addition, the step difference amount T of the phase difference layer is identified based on a cross-sectional profile of the phase difference controlling member that is measured by using an electron microscope (scanning electron microscope (SEM) JSM-5300, manufactured by Jeol Ltd.). According to the measurement result, the maximum step difference amount T of the phase difference layer is measured at the step difference formed by the front position of the overlapped portion in the red color pattern and the bottom position of the downwardly receding concave portion, and more specifically, the step difference amount is reduced from 800 nm to 400 nm.

Similarly to the first embodiment, a liquid crystal display is produced by using the phase difference controlling member. Similarly to the first embodiment, goodness or defectiveness thereof is evaluated. In the liquid crystal display using the phase difference controlling member, the light leakage is not perceived, so that the liquid crystal display is evaluated as a good liquid crystal display. It is verified that the phase difference controlling member has a good optical compensation function.

### Fourth Embodiment

Similarly to the third embodiment, a coloring layer having a black matrix and color patterns is formed as a base layer on the glass substrate. Other configurations are the same as those of the second embodiment. As a result, a phase difference controlling member is obtained. With respect to the phase difference layer of the phase difference controlling member, the thickness (d) is 1.440 μm (1440 nm), and the coefficient P is 0.020. In addition, when the thickness (d) is determined, the center of the display pixel of the green (G) color pattern is selected as the phase difference layer thickness determining position similarly to the third embodiment.

As a result, the phase difference amount (Rth) in the thickness of the phase difference layer of the phase difference controlling member is 28.8 nm, so that it is verified that the phase difference amount is an effective phase difference amount (10≦Rth≦40) as a positive C plate that exerts an optical compensation function with respect to the phase difference generated by the polarizing plate. In addition, the step difference amount T of the phase difference layer is measured similarly to the third embodiment. The maximum step difference amount of the phase difference layer is measured at the step difference formed by the front position of the overlapped portion in the red color pattern and the bottom position of the downwardly receding concave portion, and more specifically, the step difference amount is reduced from 800 nm to 360 nm.

Similarly to the third embodiment, a liquid crystal display is produced by using the phase difference controlling member. Similarly to the third embodiment, goodness or defectiveness thereof is evaluated. In the liquid crystal display using the phase difference controlling member, neither the irregularity of the orientation nor the light leakage is perceived, so that the liquid crystal display is evaluated as a good liquid crystal display. It is verified that the phase difference controlling member has a good optical compensation function.

### Comparative Example 2

As a substrate, a glass substrate (trade name: 1737 glass, manufactured by Corning Corp.) is prepared. Similarly to the third embodiment, a coloring layer having a black matrix and color patterns is formed as a base layer on the glass substrate. Other configurations are the same as those of Comparative Example 1. As a result, a structure member having a phase difference layer (comparative member 2) is obtained.

With respect to the phase difference layer of the comparative member 2, the thickness (d) is 0.940 μm (940 nm), and the coefficient P is 0.077. In addition, when the thickness (d) is determined, the center of the display pixel of the green (G) color pattern is selected as the phase difference layer thickness determining position similarly to the third embodiment. As a result, the phase difference amount (Rth) in the thickness of the phase difference layer of the phase difference controlling member 72.4 nm, so that it is verified that the phase difference amount deviates from an effective phase difference amount (10≦Rth≦40) as a positive C plate that exerts an optical compensation function. The step difference amount T of the phase difference layer is measured similarly to the third embodiment. The maximum step difference amount of the phase difference layer is measured at the step difference formed by the front position of the overlapped portion in the red color pattern and the bottom position of the downwardly receding concave portion, and more specifically, the step difference amount is slightly reduced from 800 nm to 570 nm.

In addition, similarly to the third embodiment, a liquid crystal display is produced by using the comparative member 2. Similarly to the third embodiment, goodness or defectiveness thereof is evaluated. In a liquid crystal display where the comparative member 2 is assembled, the light leakage is perceived, so that the liquid crystal display is evaluated as a defective liquid crystal display.

### Fifth Embodiment

As a substrate, a glass substrate (trade name: 1737 glass, manufactured by Corning Corp.) is prepared, and similarly to the third embodiment, a coloring layer including a black matrix and color patterns (herein, the thickness of the red (R), green (G) and blue (B) color patterns are set to 2.4 μm, 2.2 μm, and 2.3 respectively) is formed as a base layer on the glass substrate. A step difference surface is formed on the surface of the coloring layer constituting the base layer. In the step difference surface, with respect to a size of the step difference between the region corresponding to the overlapped portion in the color pattern (the region of the protruding convex portion) and the portion of the black matrix exposed through the gap region between the color patterns (downwardly receding concave portion), the maximum size is measured at the step difference formed by the front position of the overlapped portion in the red color pattern and the bottom position of the downwardly receding concave portion, and more specifically, the size is 1.7 μm.

Next, a phase difference adjusting additive material containing liquid crystal material composition that is obtained by adding 3.6 parts by weight of a polymerizable multifunctional acrylate (penta erythritol triacrylate) as a phase difference adjusting additive material to the liquid crystal material composition used in the third embodiment is adjusted. The phase difference adjusting additive material containing liquid crystal material is coated on the coloring layer, so that the liquid crystal coated layer is formed. The glass substrate where the liquid crystal coated layer is formed is maintained at 40° C., and similarly to the first embodiment, ultraviolet light is irradiated on the liquid crystal coated layer, so that the phase difference layer is formed. Other configurations are the same as those of the third embodiment. As a result, the phase difference controlling member is obtained.

With respect to the phase difference layer of the phase difference controlling member, the thickness (d) is 1.96 μm (1960 nm), and the coefficient P is 0.019. In addition, when the thickness (d) is determined, the center of the display pixel of the green (G) color pattern is selected as the phase difference layer thickness determining position similarly to the third embodiment.

As a result, the phase difference amount (Rth) in the thickness of the phase difference layer of the phase difference controlling member 39.5 nm, so that it is verified that the phase difference amount is an effective phase difference amount (10≦Rth≦40) as a positive C plate that exerts an optical compensation function with respect to the phase difference generated by the polarizing plate. In addition, the step difference amount T of the phase difference layer is measured similarly to the third embodiment. The maximum step difference amount of the phase difference layer is measured at the step difference formed by the front position of the overlapped portion in the red color pattern and the bottom position of the downwardly receding concave portion, and more specifically, the step difference amount is reduced from 1700 nm to 480 nm.

Similarly to the third embodiment, a liquid crystal display is produced by using the phase difference controlling member. Similarly to the third embodiment, goodness or defectiveness thereof is evaluated. In the liquid crystal display using the phase difference controlling member, the light leakage is not perceived, so that the liquid crystal display is evaluated as a good liquid crystal display. It is verified that the phase difference controlling member has a good optical compensation function.

### Comparative Example 3

As a substrate, a glass substrate (trade name: 1737 glass, manufactured by Corning Corp.) is prepared. Similarly to the fifth embodiment, a coloring layer having a black matrix and color patterns are formed as a base layer on the glass substrate.

Next, the liquid crystal material composition used in the fifth embodiment is coated on the coloring layer, so that the liquid crystal coated layer is formed. The glass substrate where the liquid crystal coated layer is formed is maintained at 60° C., and similarly to the fifth embodiment, ultraviolet light is irradiated on the liquid crystal coated layer, so that the liquid crystal molecules in the liquid crystal coated layer is subject to cross-linking polymerization reaction. Other configurations are the same as those of the fifth embodiment. As a result, a phase difference controlling member (comparative member 3) where a phase difference layer is formed on the substrate is obtained.

With respect to the phase difference layer of the comparative member 3, the thickness (d) is 2.010 μm (2010 nm), and the coefficient P is 0.009. In addition, when the thickness (d) is determined, the center of the display pixel of the green (G) color pattern is selected as the phase difference layer thickness determining position similarly to the fifth embodiment.

As a result, the phase difference amount (Rth) in the thickness of the phase difference layer of the phase difference controlling member 18.1 nm, so that it is verified that the phase difference amount is an effective phase difference amount (10≦Rth≦40) as a positive C plate that exerts an optical compensation function with respect to the phase difference generated by the polarizing plate. The step difference amount T of the phase difference layer is measured similarly to the third embodiment. The maximum step difference amount of the phase difference layer is measured at the step difference formed by the front position of the overlapped portion in the red color pattern and the bottom position of the downwardly receding concave portion, and more specifically, the step difference amount is reduced from 1700 nm to 490 nm.

In addition, similarly to the third embodiment, a liquid crystal display is produced by using the comparative member 3. Similarly to the third embodiment, goodness or defectiveness thereof is evaluated.

In the liquid crystal display where the comparative member 3 is assembled, it is verified that the step difference generated by the coloring layer is suppressed by laminating the phase difference layer, and the light leakage is not perceived, so that the liquid crystal display is evaluated as a good liquid crystal display. In addition, it is verified that the phase difference controlling member has a good transparent protective layer function. However, in the comparative member 3, since the phase difference layer is formed so that the thickness (d) of the phase difference layer exceeds 2000 nm, there is a problem in the yellow coloring. Particularly, when the display is in the blue display, the yellowish state is perceived on the entire surface of the liquid crystal display screen, so that bad influence to the yellow coloring is visually perceived.

### INDUSTRIAL APPLICABILITY

In a phase difference controlling member according to the present invention, in the case where the phase difference controlling member is assembled in a liquid crystal display, a step difference amount of the surface of the phase difference controlling member can be suppressed. In addition, the phase difference controlling member has an excellent optical compensation function of optically compensating for a phase difference of light generated by a polarizing plate, so that the phase difference controlling member can be effectively used as a part of the liquid crystal display.

1. A phase difference controlling member configured by laminating a phase difference layer on a step difference surface that is formed by laminating a base layer on a surface of a substrate, the phase difference controlling member wherein an optical axis of the phase difference layer is erected against a plane having a normal line in a thickness direction of the phase difference layer,
a step difference amount T of a surface of the phase difference layer is less than 500 nm, and
in the case where x and y axes perpendicular to each other are located in in-plane directions of the phase difference layer and a z axis is set to a direction of a normal line of the phase difference layer, if the x-axial refractive index of the phase difference layer is set to nx, and the y-axial refractive index is set to ny, and the z-axial refractive index is set to nz, respectively, the refractive indices nx, ny and nz and a coefficient P with respect to light having a wavelength of 589 nm have a relationship of P=(nz−((nx+ny)/2)), and the coefficient P and a thickness d (nm) of the phase difference layer satisfy the following respective formulae of
0.005≦P≦0.04 (Formula 1),
d≦2000 (Formula 2) and
10≦P×d≦40 (Formula 3).

2. The phase difference controlling member according to claim 1, wherein the base layer is a coloring layer having a black matrix and color patterns.

3. The phase difference controlling member according to claim 1, wherein the base layer is a black matrix formation layer.

4. The phase difference controlling member according to claim 1, wherein the phase difference layer is formed by coating the step difference surface with a liquid crystal material composition containing liquid crystal molecules having a polymerizable functional group and forming a liquid crystal coated layer, applying an orientation characteristic to the liquid crystal molecules included in the liquid crystal coated layer, and irradiating an activated radiation on the liquid crystal coated layer so that the liquid crystal molecules are polymerized.

5. The phase difference controlling member according to claim 2, wherein the phase difference layer is formed by coating the step difference surface with a liquid crystal material composition containing liquid crystal molecules having a polymerizable functional group and forming a liquid crystal coated layer, applying an orientation characteristic to the liquid crystal molecules included in the liquid crystal coated layer, and irradiating an activated radiation on the liquid crystal coated layer so that the liquid crystal molecules are polymerized.

6. The phase difference controlling member according to claim 1, wherein the phase difference layer is formed by coating the step difference surface with a liquid crystal material composition containing liquid crystal molecules having a polymerizable functional group and a phase difference adjusting additive material and forming a liquid crystal coated layer, applying an orientation characteristic to the liquid crystal molecules included in the liquid crystal coated layer, and irradiating an activated radiation on the liquid crystal coated layer so that the liquid crystal molecules are polymerized.

7. The phase difference controlling member according to claim 2, wherein the phase difference layer is formed by coating the step difference surface with a liquid crystal material composition containing liquid crystal molecules having a polymerizable functional group and a phase difference adjusting additive material and forming a liquid crystal coated layer, applying an orientation characteristic to the liquid crystal molecules included in the liquid crystal coated layer, and irradiating an activated radiation on the liquid crystal coated layer so that the liquid crystal molecules are polymerized.

8. A liquid crystal display being provided electrodes which are disposed to at least one of a pair of opposite substrates, and a driving liquid crystal layer formed between the pair of substrates, wherein the phase difference controlling member according to claim 1 is assembled in one of the pair of substrates.

9. A liquid crystal material composition for forming a phase difference layer laminated on a step difference surface of a phase difference controlling member, wherein the liquid crystal material composition contains liquid crystal molecules having a polymerizable functional group and a phase difference adjusting additive material, and an optical axis of the phase difference layer formed by using the liquid crystal material composition being erected against a plane having a normal line in a thickness direction of the phase difference layer,
a step difference amount T of a surface of the phase difference layer is less than 500 nm, and
in the case where x and y axes perpendicular to each other are located in in-plane directions of the phase difference layer and a z axis is set to a direction of a normal line of the phase difference layer, if the x-axial refractive index of the phase difference layer is set to nx, and the y-axial refractive index is set to ny, and the z-axial refractive index is set to nx, respectively, the refractive indices nx, ny and nz and a coefficient P with respect to light having a wavelength of 589 nm have a relationship of P=(nz−((nx+ny)/2)), and the coefficient P and a thickness d (nm) of the phase difference layer satisfy the following respective formulae of
0.005≦P≦0.04 (Formula 1),
d≦2000 (Formula 2) and
10≦P×d≦40 (Formula 3).

10. A liquid crystal display being provided electrodes which are disposed to at least one of a pair of opposite substrates, and a driving liquid crystal layer formed between the pair of substrates, wherein the phase difference controlling member according to claim 2 is assembled in one of the pair of substrates.

11. A liquid crystal display being provided electrodes which are disposed to at least one of a pair of opposite substrates, and a driving liquid crystal layer formed between the pair of substrates, wherein the phase difference controlling member according to claim 3 is assembled in one of the pair of substrates.

12. A liquid crystal display being provided electrodes which are disposed to at least one of a pair of opposite substrates, and a driving liquid crystal layer formed between the pair of substrates, wherein the phase difference controlling member according to claim 4 is assembled in one of the pair of substrates.

13. A liquid crystal display being provided electrodes which are disposed to at least one of a pair of opposite substrates, and a driving liquid crystal layer formed between the pair of substrates, wherein the phase difference controlling member according to claim 5 is assembled in one of the pair of substrates.

14. A liquid crystal display being provided electrodes which are disposed to at least one of a pair of opposite substrates, and a driving liquid crystal layer formed between the pair of substrates, wherein the phase difference controlling member according to claim 6 is assembled in one of the pair of substrates.

15. A liquid crystal display being provided electrodes which are disposed to at least one of a pair of opposite substrates, and a driving liquid crystal layer formed between the pair of substrates, wherein the phase difference controlling member according to claim 7 is assembled in one of the pair of substrates.
